(19) United States
(12) Patent Application Publication
(10) Pub. No.: US 2011/0242433 A1
(43) Pub. Date: Oct. 6, 2011

(54) LIGHTING DEVICE, DISPLAY DEVICE AND TELEVISION RECEIVER

(75) Inventors: Shodo Yamasaki, Osaka (JP); Akiyoshi Miyatani, Osaka (JP); Tomoaki Oya, Osaka (JP)

(73) Assignee: SHARP KABUSHIKI KAISHA, Osaka-shi, Osaka (JP)

(21) Appl. No.: 13/125,051

(22) PCT Filed: Jul. 13, 2009
(86) PCT No.: PCT/JP2009/062656

§ 371 Date: Jun. 16, 2011

(30) Foreign Application Priority Data
Oct. 27, 2008 (JP) 2008-276004

(51) Int. Cl. H04N 5/66; F21V 7/22; G02F 1/13357

(52) U.S. Cl. 348/739; 362/606; 349/65; 348/E05.133

(57) ABSTRACT

A backlight unit 12 includes LEDs 16, light guide plates 18 and air layers AR1 having a reflective index lower than the light guide member. Each of the light guide plates 18 includes a light entrance surface 34 provided to face the LED 16 and that light from the LED 16 enters, and a light exit surface 36 provided to be parallel to an arrangement direction in which the LED 16 and the light entrance surface 34 are arranged and through which the light exits. The light guide members 18 are arranged in a vertical direction that is the arrangement direction and in a horizontal direction that is a direction parallel to the light exit surface 36 and perpendicular to the arrangement direction. The air layer AR1 is provided between the horizontally adjacent light guide members 18. The air layer AR1 between the light guide plates 18 of one set of the horizontally-arranged light guide plates is offset from the air layer AR1 between the light guide plates 18 of another set of the horizontally-arranged light guide plates that is next to the one set.

### TECHNICAL FIELD

The present invention relates to a lighting device, a display device and a television receiver.

### BACKGROUND ART

In recent years, displays of image display devices including television receivers are shifting from conventional cathode-ray tube displays to thin-screen displays including liquid crystal panels and plasma display panels. With the thin-screen displays, thin image display devices can be provided. A liquid crystal display device requires a backlight unit as a separate lighting device because a liquid crystal panel used therein is not a light-emitting component.

For example, a liquid crystal display device reducing its thickness and increasing its size disclosed in Patent Document 1 has been known. The liquid crystal display device includes LEDs and light guide plates. Each of the LEDs has a light emitting surface that emits rays of light in a direction substantially parallel to the display surface of the liquid crystal panel. Each of the light guide plates has a light entrance surface in its side-edge area and a light exit surface on its upper surface. The light entrance surface faces the LED and rays of light emitting from the LED strike the light entrance surface. The rays of light exit through the light exit surface toward the display surface of the liquid crystal panel. The light guide plates and the LEDs are arranged horizontally. A reflecting layer is provided between facing surfaces of the adjacent light guide plates. The rays of light traveling through the light guide plate reflect off the reflecting layer and are directed toward the light exit surface.

Patent Document 1: Japanese Published Patent Application No. 2006-108045

### PROBLEM TO BE SOLVED BY THE INVENTION

In the above-mentioned backlight unit, rays of light travel through the light guide plate via the reflecting layer. An air layer a reflective index of which is lower than the light guide plate may be provided between the adjacent light guide plates so that the rays of light traveling through the light guide plate totally reflect off the interface between the light guide plate and the air layer. Accordingly, the rays of light are directed to the light exit surface.

With the above-mentioned method, a predetermined gap is required between the adjacent light guide plates to ensure the air layer. The amount of rays of light emitting from the gap is insufficient compared to the one emitting from the light exit surface. Therefore, the gap is likely to be recognized as a dark point.

If the liquid crystal display device is further required to increase in size, a number of light guide plates may be arranged in a grid. With this configuration, the air layers provided between the light guide plates that are horizontally arranged are continuously arranged in a vertical direction. Therefore, the air-layer areas are likely to be recognized as dark lines crossing a screen of the liquid crystal display device. This may cause uneven brightness.

### DISCLOSURE OF THE PRESENT INVENTION

The present invention was made in view of the foregoing circumstances. An object of the present invention is to keep uneven brightness from occurring.

### MEANS FOR SOLVING THE PROBLEM

A lighting device of the present invention includes a light source, light guide members, and a low reflective index layer having a reflective index lower than the light guide members. Each light guide member includes a light entrance surface provided to face the light source and that light from the light source enters, and a light exit surface provided to be parallel to an arrangement direction in which the light source and the light entrance surface are arranged and through which the light exits. The light guide members are arranged in a vertical direction that is the arrangement direction and in a horizontal direction that is a direction parallel to the light exit surface and perpendicular to the arrangement direction. The low index layer is provided between adjacent light guide members that are arranged in the horizontal direction. The low reflective index layer between the light guide members of one set of the horizontally-arranged light guide members is offset from the low reflective index layer between the light guide members of another set of the horizontally-arranged light guide members that is next to the one set.

Light emitting from the light source strikes the light entrance surface. The light is totally reflected at the interface with the low reflective index layer while traveling through the light guide member effectively and exits from the light exit surface. The light is less likely to leak from the light guide member to the low reflective index layer between the horizontally adjacent light guide members. Therefore, the amount of rays of light exiting from the low reflective index layer is relatively different from that exiting from the light exit surface. As mentioned before, the light guide members are arranged as follows. The low reflective index layer between the light guide members of one set of the horizontally-arranged light guide members is offset from the low reflective index layer between the light guide members of another set of the horizontally-arranged light guide members that is next to the one set. Therefore, the low reflective index layers are not provided continuously in the vertical direction. Accordingly, the low reflective index layer areas are less likely to be recognized as uneven brightness areas. The amount of rays of light exiting from the low reflective index layer areas is different from that exiting from the light exit surface.

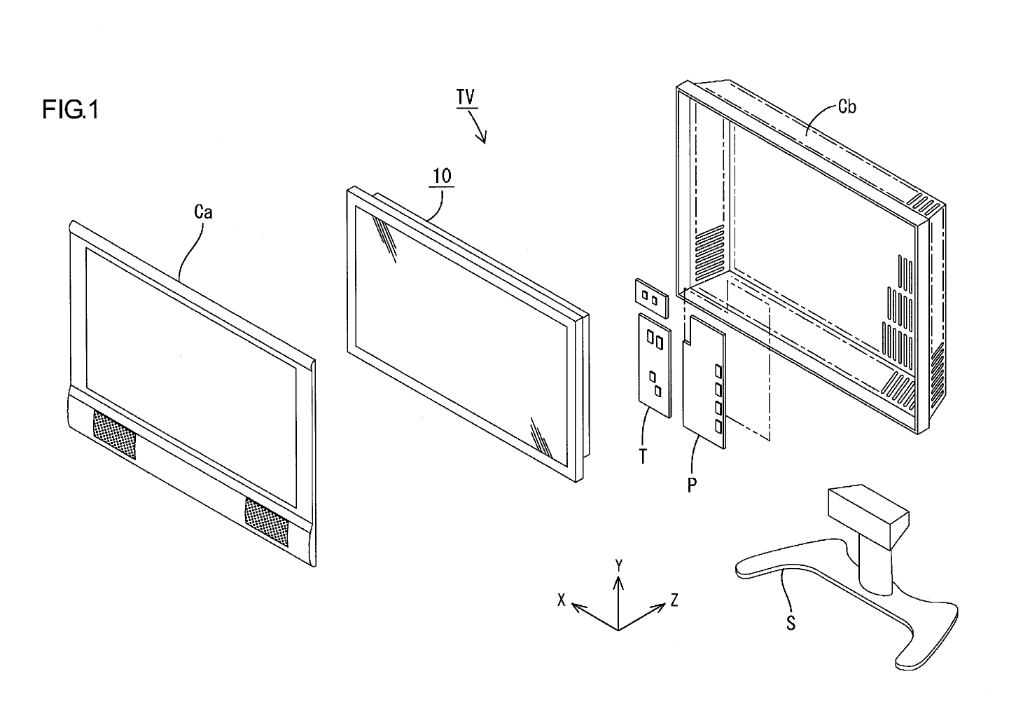

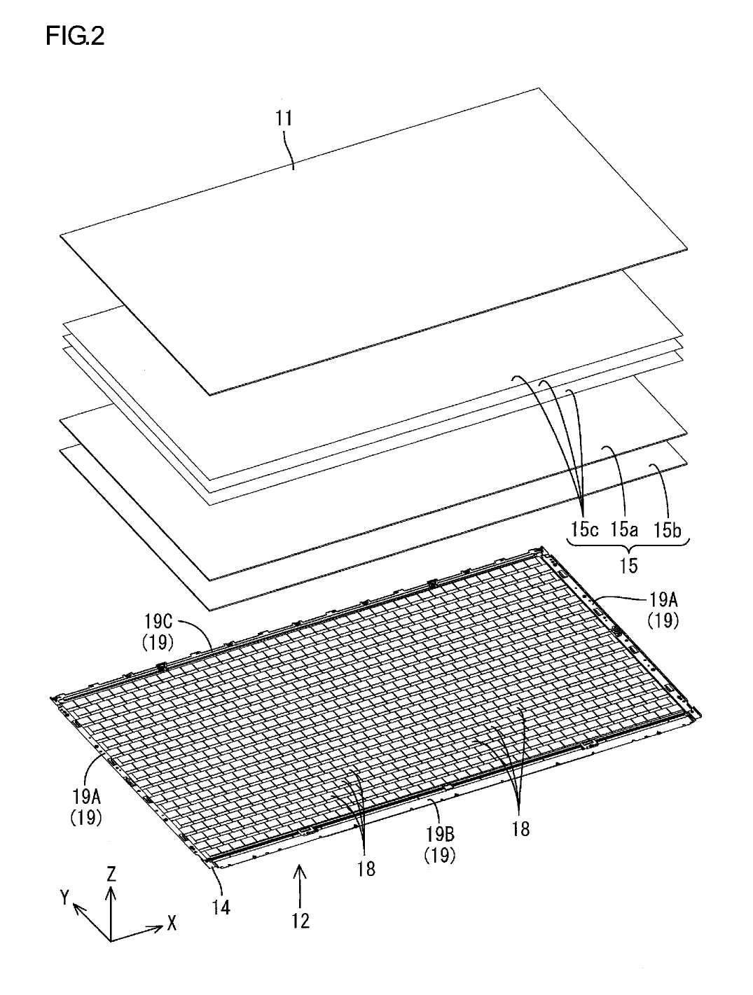

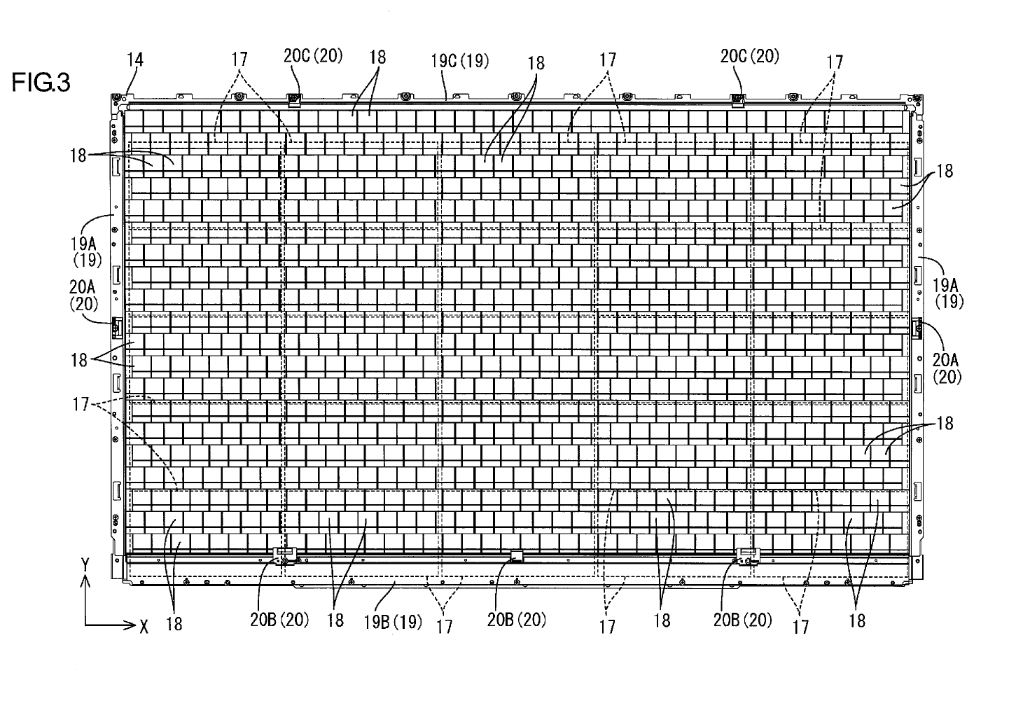

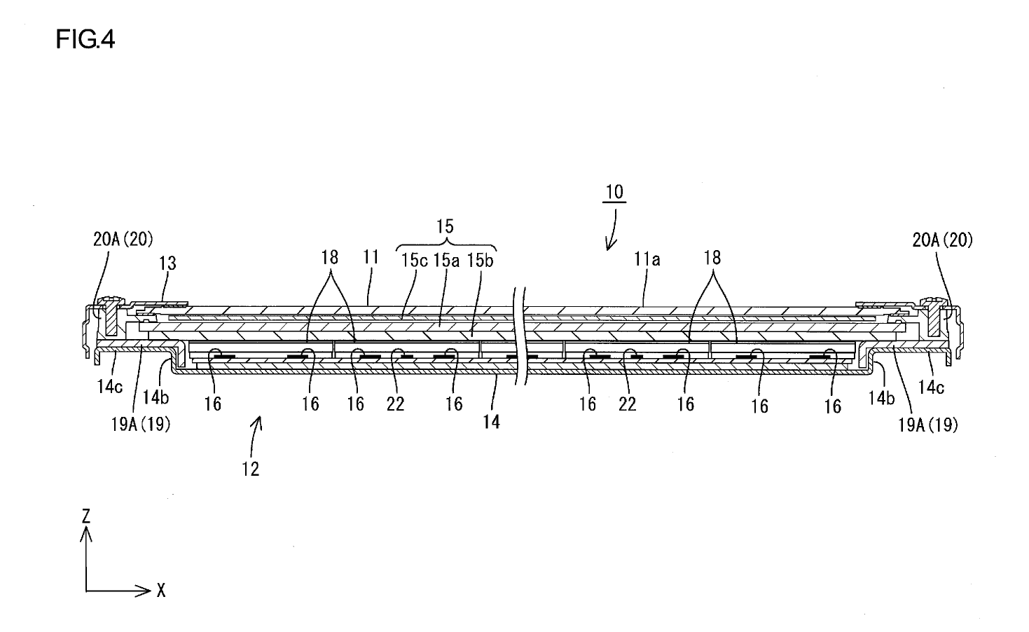

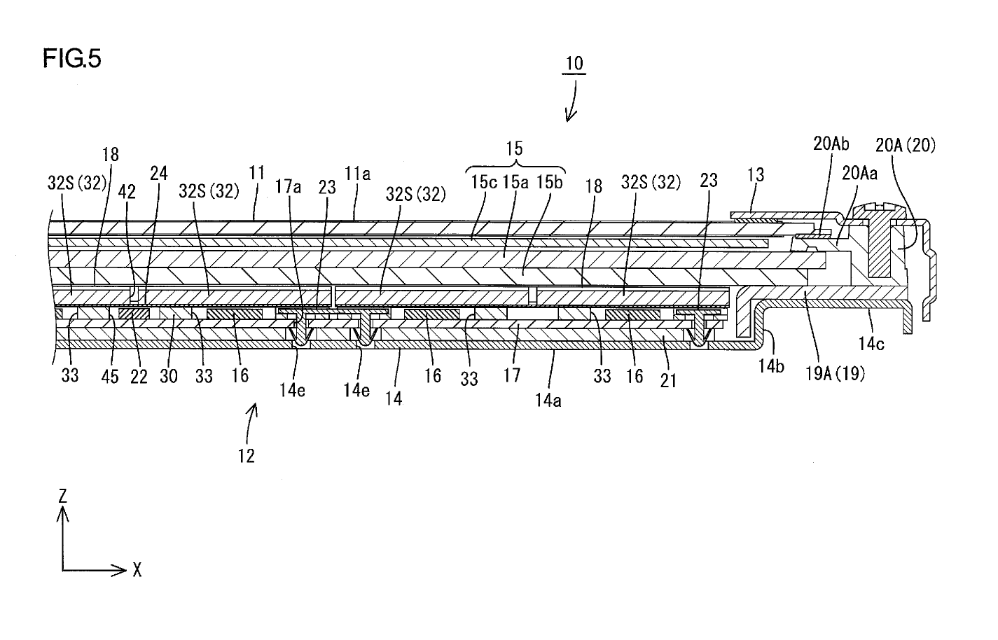

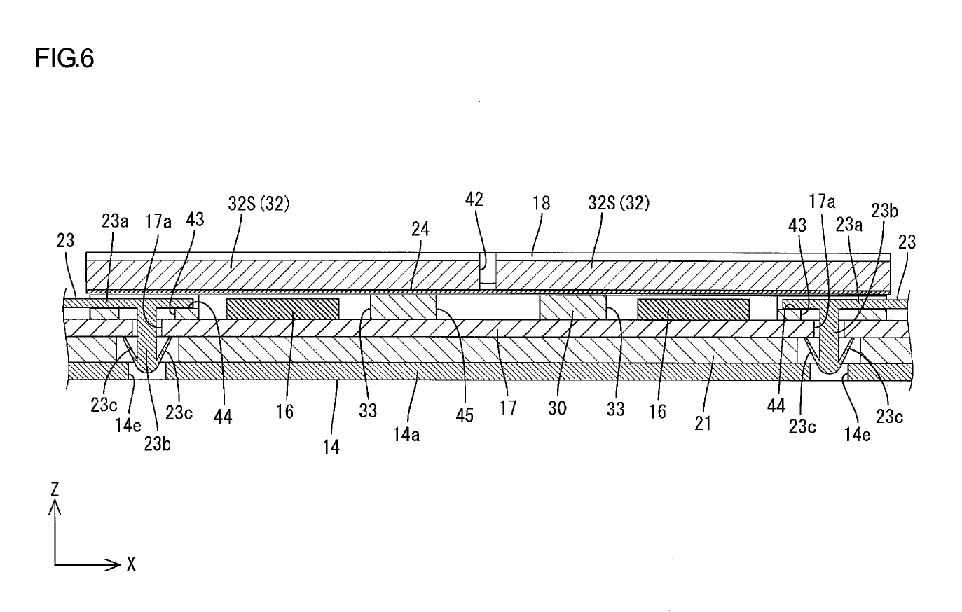

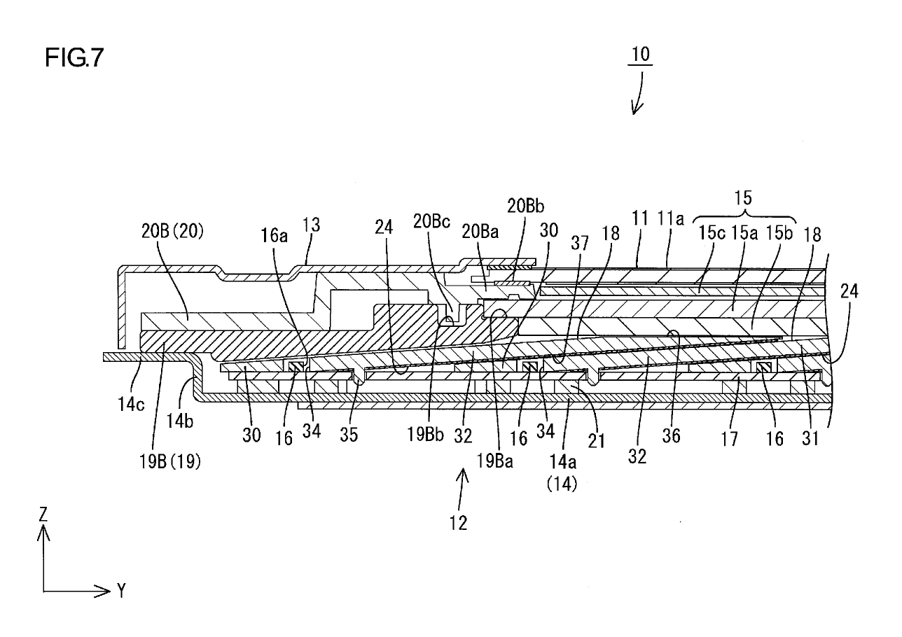

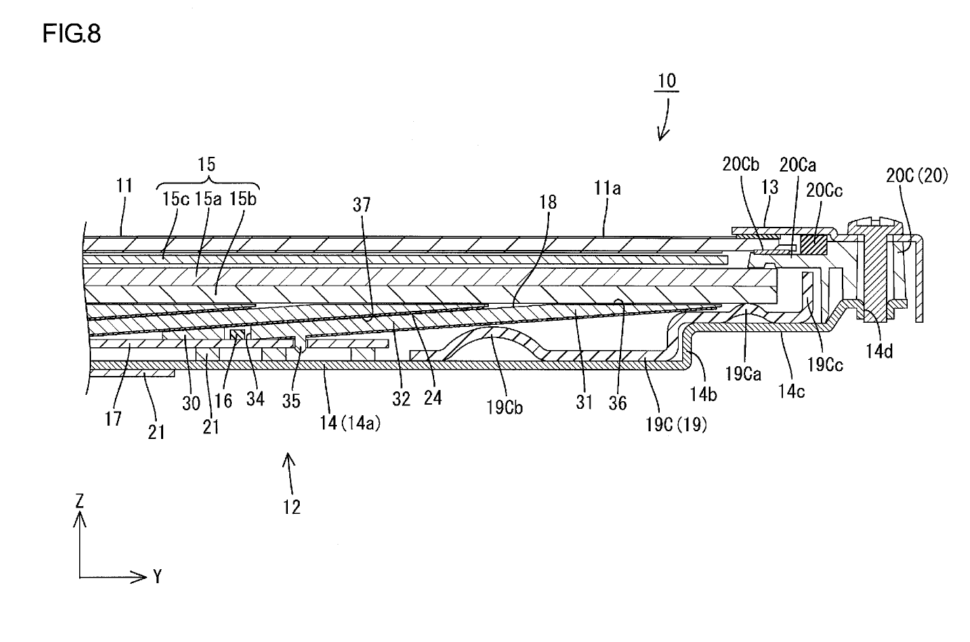

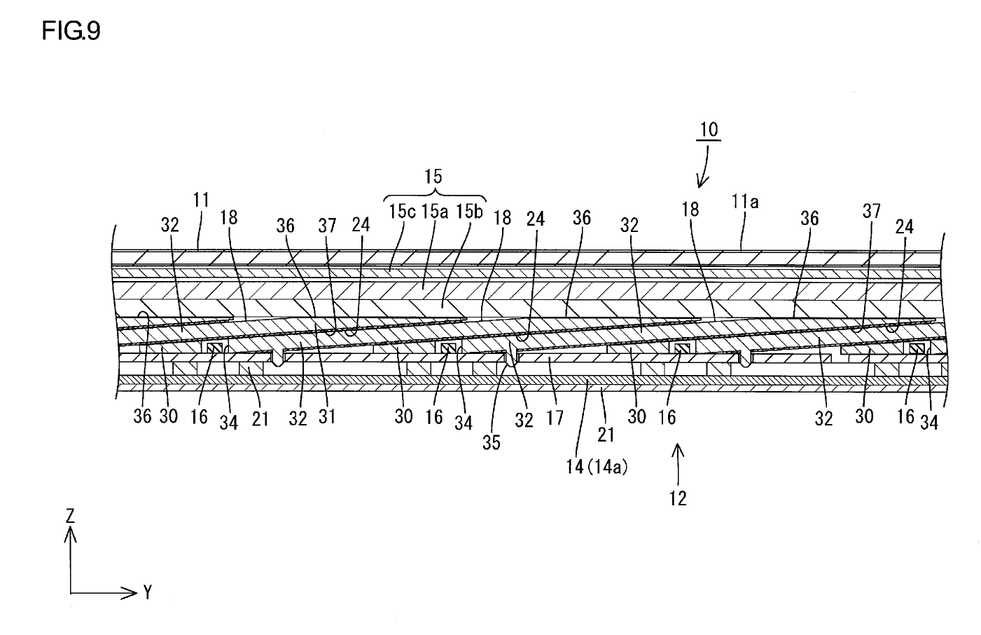

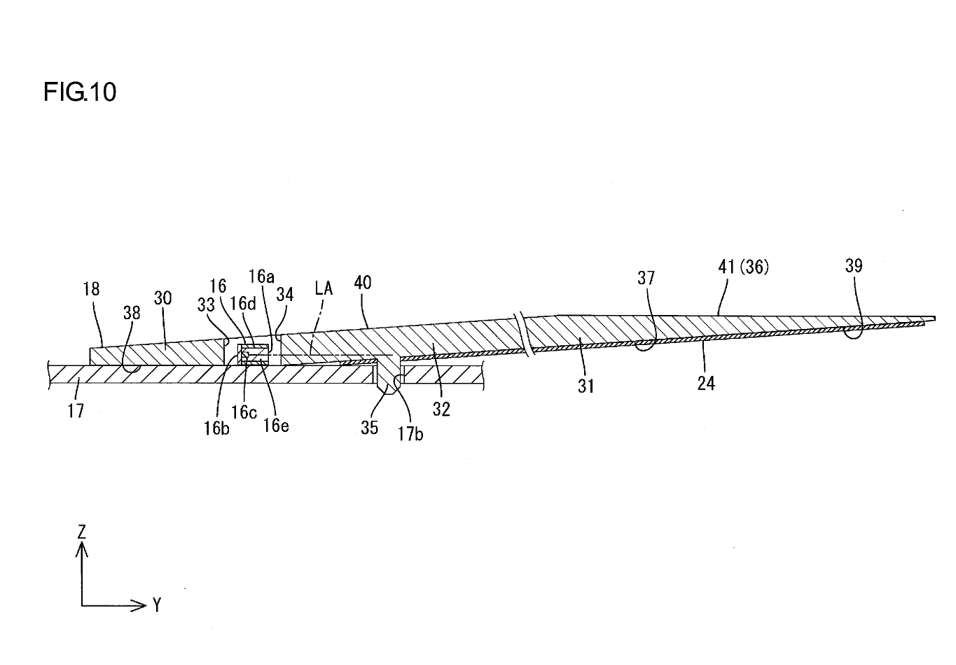

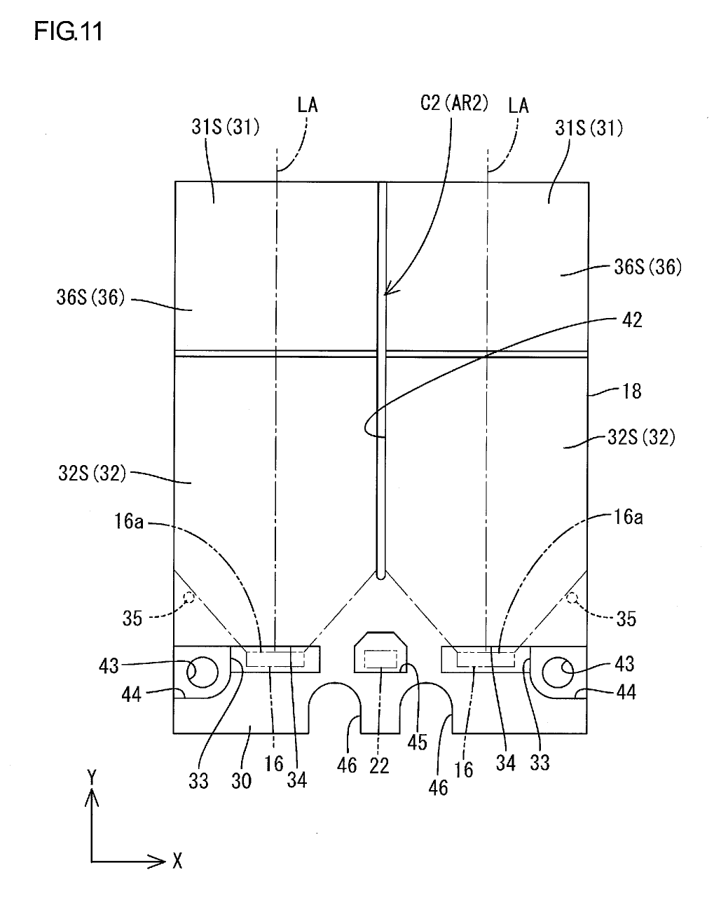

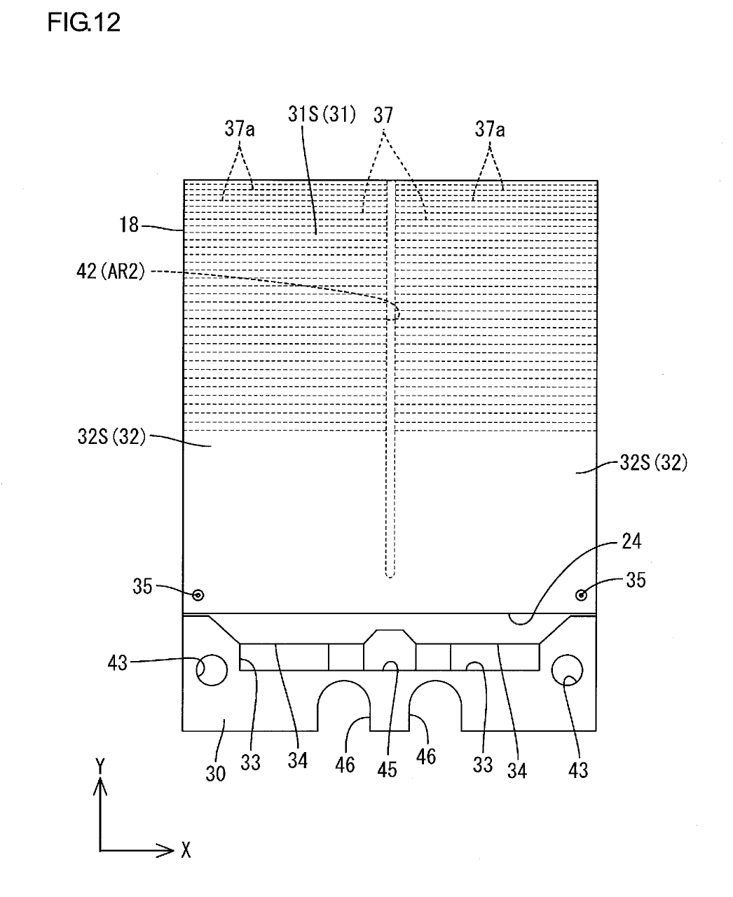

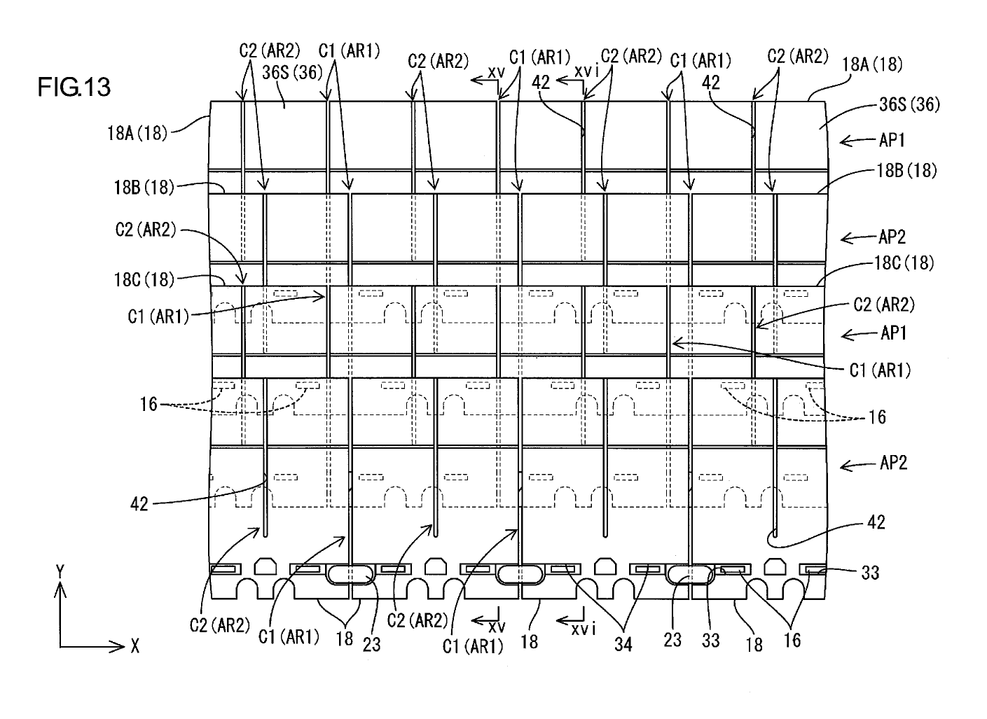

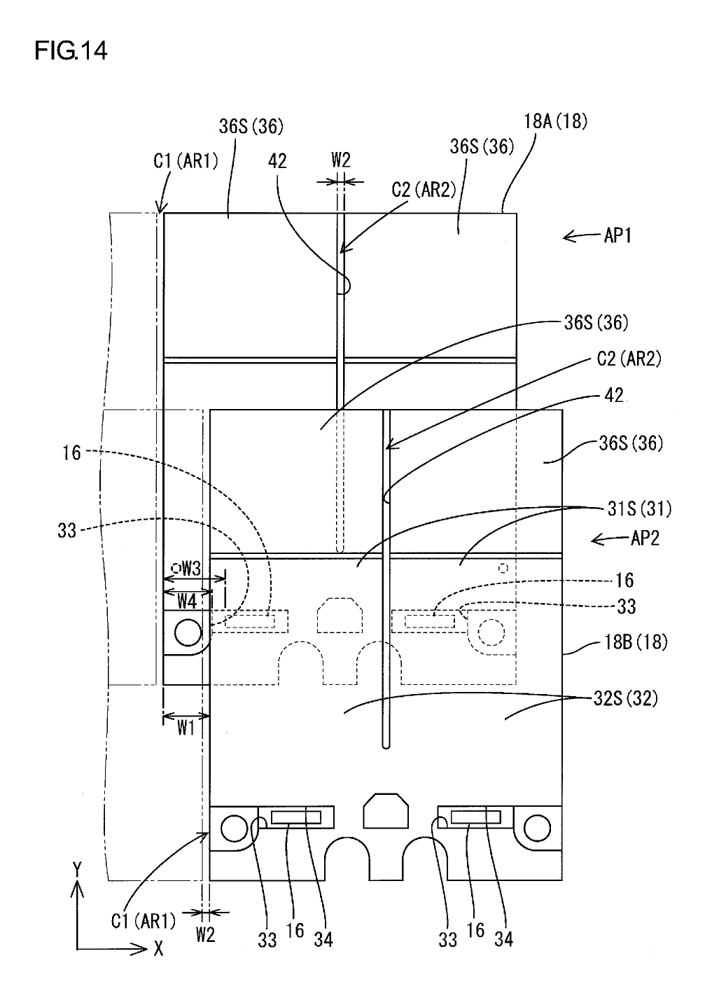

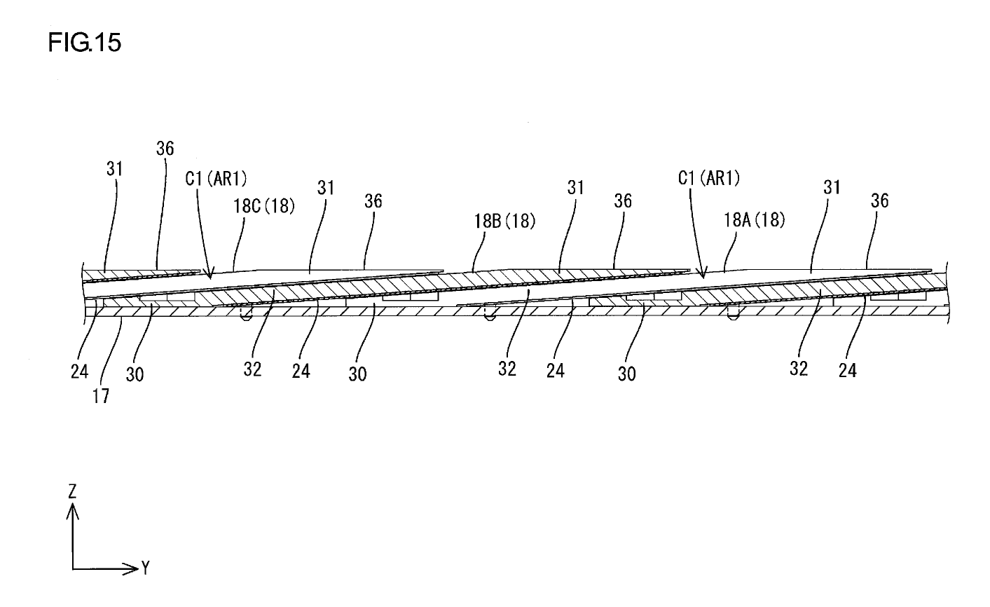

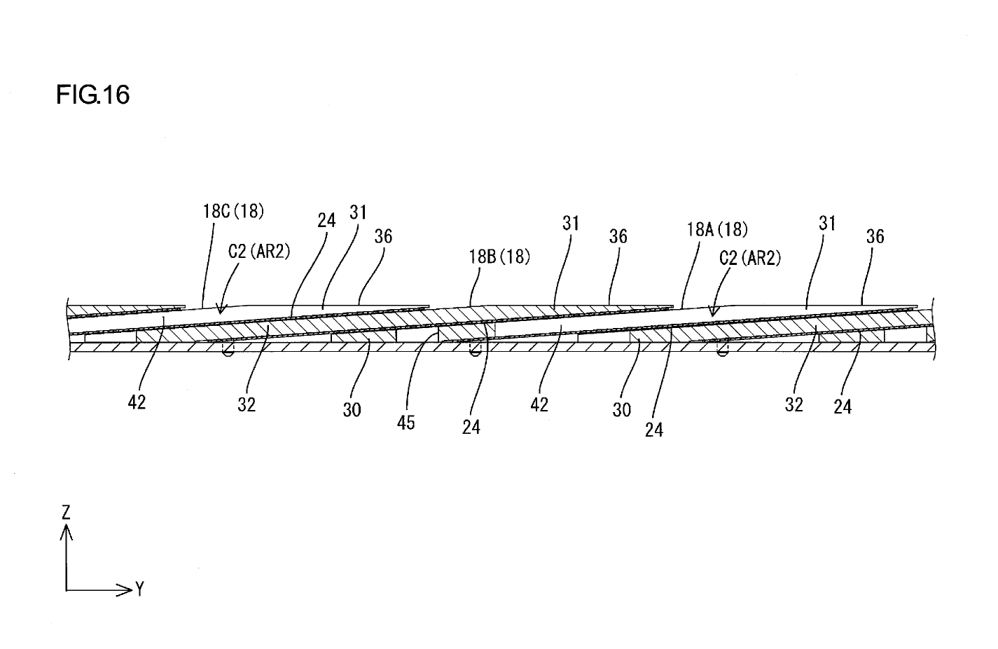

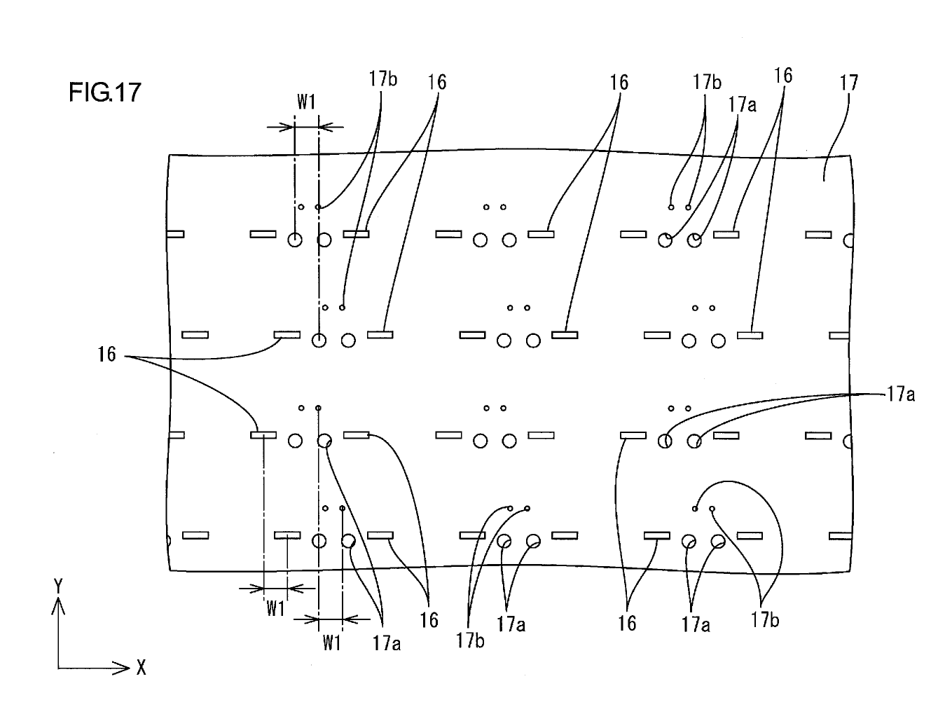

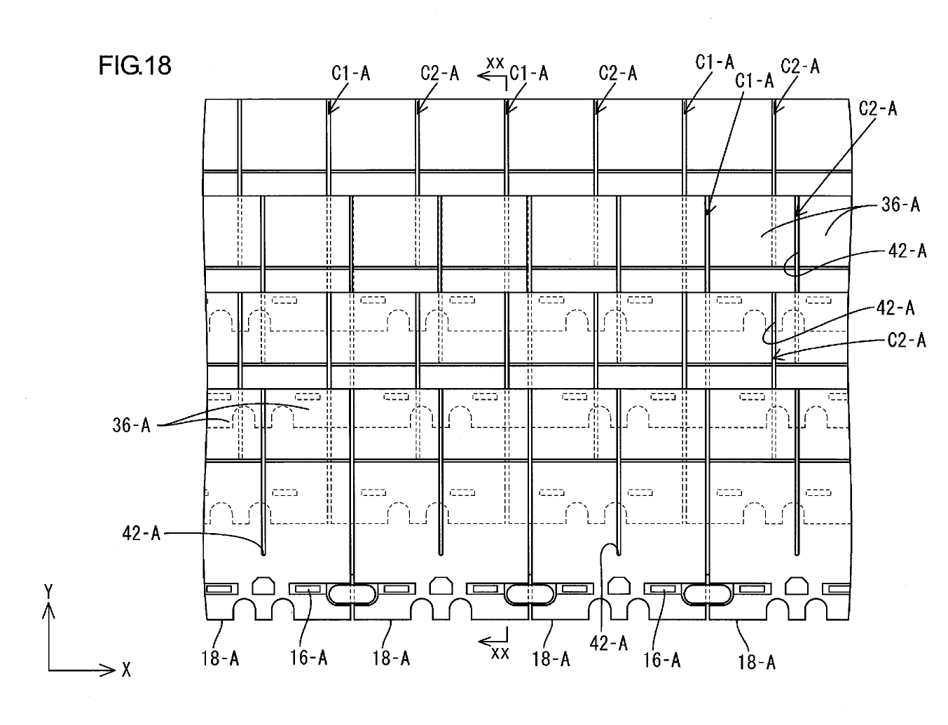

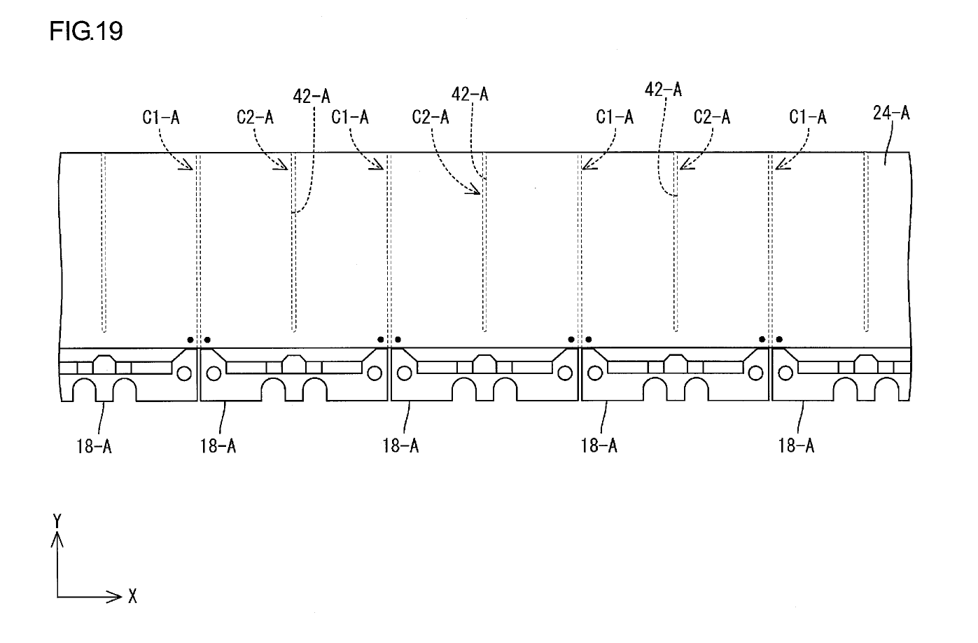

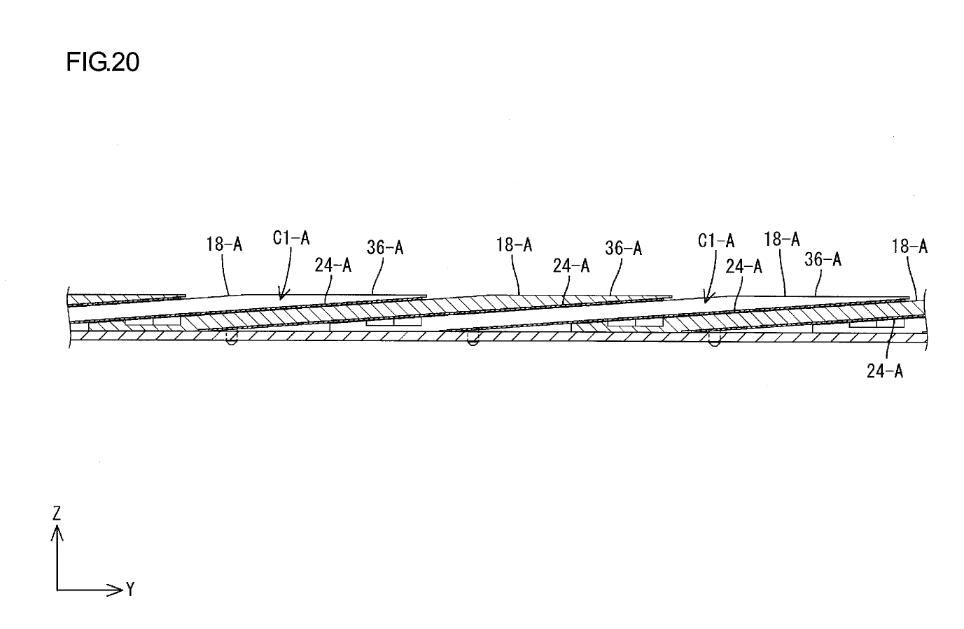

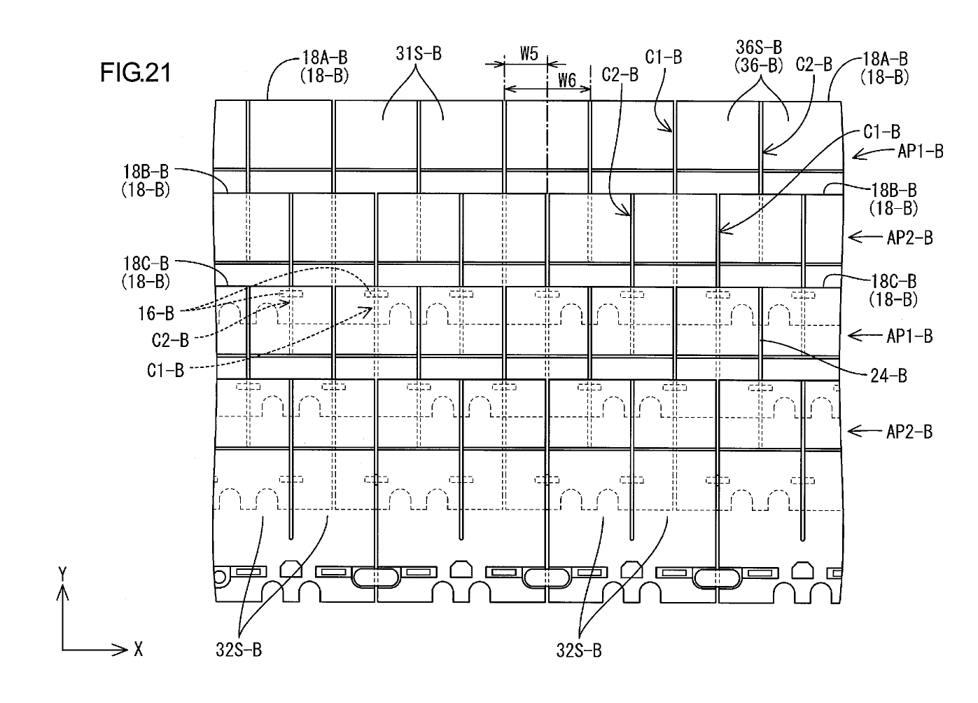

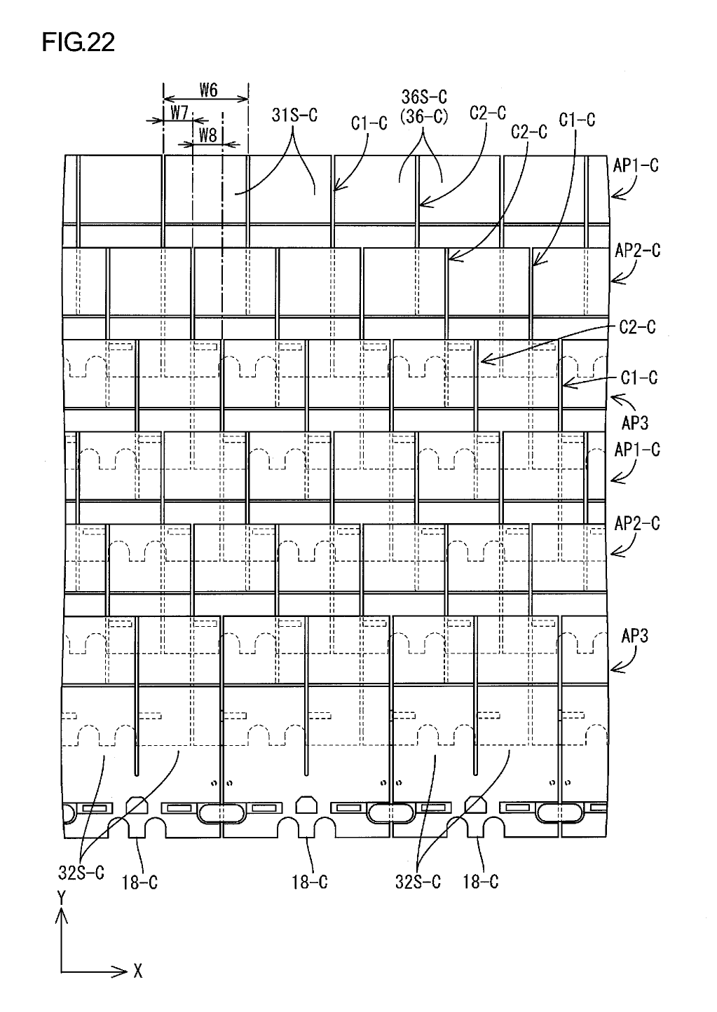

### BRIEF DESCRIPTION OF THE DRAWINGS

[FIG. 1] is an exploded perspective view illustrating a general construction of a television receiver according to the first embodiment of the present invention;

[FIG. 2] is an exploded perspective view illustrating a general construction of a liquid crystal panel and a backlight unit;

[FIG. 3] is a plan view of the backlight unit;

[FIG. 4] is a cross-sectional view of a liquid crystal display device along the long side thereof;

[FIG. 5] is a magnified cross-sectional view of an end portion of the liquid crystal display device in FIG. 4;

[FIG. 6] is a magnified cross-sectional view of a light guide plate illustrated in FIG. 5;

[FIG. 7] is a magnified cross-sectional view of a lower end portion of the liquid crystal display device in FIG. 3 along the short side thereof;

[FIG. 8] is a magnified cross-sectional view of an upper end portion of the liquid crystal display device in FIG. 3 along the short side thereof;

[FIG. 9] is a magnified cross-sectional view of a middle portion of the liquid crystal display device along the short side thereof;

[FIG. 10] is a magnified cross-sectional view of a light guide plate in FIG. 9;

[FIG. 11] is a plan view of the light guide plate;

[FIG. 12] is a bottom view of the light guide plate;

[FIG. 13] is a plan view illustrating a layout of the light guide plates;

[FIG. 14] is a magnified plan view of the light guide plate for a first arrangement pattern and the light guide plate for a second arrangement pattern in FIG. 13;

[FIG. 15] is a cross-sectional view of the light guide plates taken along a xv-xv line in FIG. 13;

[FIG. 16] is a cross-sectional view of the light guide plates taken along a xvi-xvi line in FIG. 13;

[FIG. 17] is a plan view of an LED board;

[FIG. 18] is a plan view illustrating a layout of light guide plates according to a second embodiment of the present invention;

[FIG. 19] is a bottom view of a number of light guide plates and a number of reflecting sheets that are horizontally arranged;

[FIG. 20] is a cross-sectional view of the light guide plates taken along a xx-xx line in FIG. 18;

[FIG. 21] is a plan view illustrating a layout of light guide plates according to a third embodiment of the present invention; and

[FIG. 22] is a plan view illustrating a layout of light guide plates according to a fourth embodiment of the present invention.

### BEST MODE FOR CARRYING OUT THE INVENTION

### First Embodiment

The first embodiment of the present invention will be explained with reference to FIGS. 1 to 17. In this embodiment, a liquid crystal display device 10 will be explained. X-axes, Y-axes and Z-axes in some figures correspond to each other so as to indicate the respective directions. In FIGS. 4 to 10, the upper side and the lower side correspond to the front-surface side and the rear-surface side, respectively.

As illustrated in FIG. 1, the television receiver TV includes the liquid crystal display device 10 (a display device), cabinets Ca and Cb, a power source P, and a tuner T. The cabinets Ca and Cb sandwich the liquid crystal display device 10 therebetween. The liquid crystal display device 10 is housed in the cabinets Ca and Cb. The liquid crystal display device 10 is held by a stand S in a vertical position in which a display surface 11a is set along a substantially vertical direction (the Y-axis direction). The liquid crystal display device 10 has a landscape rectangular overall shape. As illustrated in FIG. 2, the liquid crystal display device 10 includes a liquid crystal panel 11, which is a display panel, and a backlight unit 12 (an example of a lighting device), which is an external light source. The liquid crystal panel 11 and the backlight unit 12 are held together by a frame-shaped bezel 13 as illustrated in FIG. 2.

“The display surface 11a is set along the vertical direction” is not limited to a condition that the display surface 11a is set parallel to the vertical direction. The display surface 11a may be set along a direction closer to the vertical direction than the horizontal direction. For example, the display surface 11a may be 0° to 45° slanted to the vertical direction, preferably 0° to 30° slanted.

Next, the liquid crystal panel 11 and the backlight unit 12 included in the liquid crystal display device 10 will be explained. The liquid crystal panel (a display panel) 11 has a rectangular plan view and includes a pair of transparent glass substrates bonded together with a predetermined gap therebetween and liquid crystals sealed between the substrates. On one of the glass substrates, switching components (e.g., TFTs), pixel electrodes and an alignment film are arranged. The switching components are connected to gate lines and the source lines that are perpendicular to each other. The pixel electrodes are connected to the switching components. On the other glass substrate, color filters including R (red) G (green) B (blue) color sections in predetermined arrangement, a counter electrode and an alignment film are arranged. Polarizing plates are arranged on outer surfaces of the glass substrates, respectively (see FIG. 5).

Next, the backlight unit 12 will be explained in detail. As illustrated in FIG. 4, the backlight unit 12 includes a chassis 14, an optical member 15, LEDs 16 (light emitting diodes), LED boards 17 and light guide plates 18. The chassis 14 has a box-like overall shape and an opening on the front side (the liquid crystal panel 11 side, the light output side). The optical member 15 is arranged so as to cover the opening. The LEDs 16 are light sources arranged inside the chassis 14. The LEDs 16 are mounted on the LED boards 17. Rays of light emitted from the LEDs 16 are directed to the optical member 15 by the light guide plates 18. The backlight unit 12 further includes a support member 19, a holddown member 20 and heat sinks 21. The support member 19 holds diffusers 15a and 15b included in the optical member 15 from the rear side. The holddown member 20 holds down the diffusers 15a and 15b from the front side. The heat sinks 21 are provided for dissipation of heat generated while the LEDs 16 emit light.

The backlight unit 12 includes a number of unit light emitters arranged in series. Each unit light emitter includes the light guide plate 18 and the LEDs 16 arranged in series. The LEDs 16 are disposed in side-edge areas of each light guide plate 18. A number of the unit light emitters (twenty of them in FIG. 3) are arranged in series along an arrangement direction (an Y-axis direction) in which the LEDs 16 and the light guide plates 18 are arranged in series, that is, in a tandem layout (see FIGS. 7 to 9). Furthermore, the backlight unit 12 includes a number of the unit light emitters (forty of them in FIG. 3) arranged parallel to each other in a direction substantially perpendicular to the tandem arrangement direction (the Y-axis direction) and along the display surface 11a (the X-axis direction). Namely, a number of the unit light emitters are arranged in a plane (i.e., in a two-dimensional parallel layout) along the display surface 11a (the X-Y plane) (see FIG. 3). In other words, the light guide plates 18 and the LEDs 16 of the unit light emitter are arranged in series vertically (a vertical direction, the Y-axis direction) and horizontally (a horizontal direction, the X-axis direction). The vertical direction corresponds to the tandem-arrangement direction and the horizontal direction corresponds to a direction substantially perpendicular to the tandem-arrangement direction and parallel to the display surface 11a (the light exit surface 36).

Next, components of the backlight unit 12 will be explained in detail. The chassis 14 is made of metal and has a shallow-box-like overall shape (or a shallow-bowl-like overall shape) with the opening on the front-surface side as illustrated in FIG. 4. The chassis 14 includes a bottom plate 14a, side plates 14b and support plates 14c. The bottom plate 14a has a rectangular shape similar to the liquid crystal panel 11. The side plates 14b rise from the respective edges of the bottom plate 14a. The support plates 14c project outward from the respective end edges of the side plates 14b. The long-side direction and the short-side direction of the chassis 14 correspond to the horizontal direction (the X-axis direction) and the vertical direction (the Y-axis direction), respectively. The support plates 14c of the chassis 14 are configured such that the support member 19 and the holddown member 20 are placed thereon, respectively, from the front-surface side. Each support plate 14c has mounting holes 14d that are through holes for holding the bezel 13, the support member 19 and the holddown member 20 together with screws and formed at predetermined positions. One of the mounting holes 14d is illustrated in FIG. 8. An outer edge portion of each support plate 14c on the long side is folded so as to be parallel to the corresponding side plate 14b (see FIG. 4). The bottom plate 14a has insertion holes 14e that are through holes for inserting clips 23 therein (see FIGS. 5 and 6). The light guide plates 18 are mounted to the chassis with the clips 23. The bottom plate 14a also has mounting holes (not shown). The mounting holes are through holes for mounting the LED boards 17 with screws and formed at predetermined positions.

As illustrated in FIG. 4, the optical member 15 is arranged between the liquid crystal panel 11 and the light guide plates 18. It includes the diffusers 15a and 15b arranged on the light guide plate 18 side, and an optical sheet 15c arranged on the liquid crystal panel 11 side. Each of the diffusers 15a and 15b includes a transparent resin base material with a predefined thickness and a large number of diffusing particles scattered in the base material. The diffusers 15a and 15b have functions of diffusing light that passes therethrough. The diffusers 15a and 15b having the same thickness are placed on top of each other. The optical sheet 15c is a thin sheet having a smaller thickness than that of the diffusers 15a and 15b. The optical sheet 15c includes three sheets placed on top of each other, more specifically, a diffusing sheet, a lens sheet and a reflection-type polarizing sheet arranged in this order from the diffuser 15a (15b) side (i.e., from the rear-surface side).

The support member 19 is arranged on outer edge portions of the chassis 14 so as to support almost entire outer edge portions of the diffusers 15a and 15b. As illustrated in FIG. 3, the support member 19 includes a pair of short-side support parts 19A and two different long-side support parts 19B and 19C. The short-side support parts 19A are arranged so as to extend along the respective short sides of the chassis 14. The long-side support parts 19B and 19C are arranged so as to extend along the respective long sides of the chassis 14. The parts of the support member 19 are configured differently according to mounting locations. The symbols 19A to 19C are used for referring to the parts of the support member 19 independently. To refer to the support member 19 as a whole, the numeral 19 without the letters is used.

As illustrated in FIGS. 4 and 5, the short-side support parts 19A have substantially same configurations. Each of them has a substantially L-shape cross section so as to extend along a surface of the support plate 14c and an inner surface of the side plate 14b. A part of each short-side support part 19A parallel to the support plate 14c receives the diffuser 15b in an inner area and a short-side holddown part 20A in an outer area. The short-side holddown part 20A will be explained later. The short-side support parts 19A cover substantially entire lengths of the support plates 14c and the side plates 14b on the short sides.

The long-side support parts 19B and 19C are configured differently. Specifically, the first long-side support part 19B is arranged on the lower side in FIG. 3 (the lower side in the vertical direction) of the chassis 14. As illustrated in FIG. 7, it is arranged so as to extend along the inner surface of the support plate 14c and a surface of the adjacent light guide plate 18 located on the front-surface side (a surface opposite from the LED board 17 side). The first long-side support part 19B has a function of pressing the adjacent light guide plate 18 from the front-surface side. The first long-side support part 19B receives the diffuser 15a that is located on the front-surface side in the inner-edge area, and the first long-side holddown part 20B in the outer-edge area. The first long-side holddown part 20B will be explained later. The inner-edge area of the first long-side support part 19B has a stepped portion 19Ba formed so as to correspond to the shape of the outer edge area of the diffuser 15a that is located on the front-surface side. Adjacent to the stepped portion 19Ba, recesses 19Bb for receiving protrusions 20Bc of the first long-side holddown part 20B are formed in the first long-side support part 19B on the outer side with respect to the stepped portions 19Ba. The first long-side holding part 19B covers substantially entire lengths of the support plate 14c on the long side and non-luminous portions of the adjacent light guide plates 18 (a board mounting portion 30 and a light guide portion 32). The width of the first long-side support part 19B is larger than those of the other support parts 19A and 19C by an area that covers the non-luminous portion.

The second long-side support part 19C is arranged on the upper side of the chassis 14 in FIG. 3 (the upper side in the vertical direction). As illustrated in FIG. 8, the second long-side support part 19C has a crank-like cross section. It is arranged along the inner surfaces of the support plate 14c, the side plate 14b and the bottom plate 14a. A diffuser support protrusion 19Ca is formed in an area of the long-side support part 19C parallel to the support plate 14c so as to protrude on the front-surface side. The diffuser support protrusion 19Ca has an arch-shaped cross section. It is brought into contact with the diffuser 15b on the rear-surface side from the rear-surface side. A light guide plate support protrusion 19Cb is formed in an area of the second long-side support part 19C parallel to the bottom plate 14a so as to protrude on the front-surface side. The light guide plate support protrusion 19Cb has an arch-shaped cross section. It is brought into contact with the adjacent light guide plate 18 from the rear-surface side. The second long-side support part 19C has functions of receiving the diffusers 15a and 15b (i.e., support functions) and light guide plate 18. An area of the second long-side holding part 19C parallel to the support plate 14c and inside with respect to the diffuser support protrusion 19Ca is brought into contact with the end portion of the light guide plate 18 from the rear-surface side. The light guide plate 18 is supported at two points: at the end portion with the support protrusion 19Ca and at the base portion with the light guide support protrusion 19Cb. The second long-side support part 19C covers substantially entire areas of the support plate 14c and the side plate 14b on the long side. A projecting portion 19Cc rises from the outer edge of the second long-side holding part 19C so as to face the end surfaces of the diffusers 15a and 15b.

As illustrated in FIG. 3, the holddown member 20 is arranged on outer edge areas of the chassis 14. A width of the holddown member 20 is smaller than a dimension of the corresponding short sides of the chassis 14 and the diffusers 15a and 15b. Therefore, the holddown member 20 presses parts of the outer edge portion of the diffusers 15a. The holddown member 20 includes short-side holddown parts 20A arranged on the respective short-edge area of the chassis 14 and a plurality of long-side holddown parts 20B and 20C arranged on each long-edge area of the chassis 14. The parts of the holddown member 20 are configured differently according to mounting locations. The symbols 20A to 20C are used for referring to the parts of the holddown member 20 independently. To refer to the holddown member 20 as a whole, the numeral 20 without the letters is used.

The short-side holddown parts 20A are arranged around central portions of the respective short-edge areas of the chassis 14. They are placed on the outer-edge portions of the short-side support parts 19A and fixed with screws. As illustrated in FIGS. 4 and 5, each short-side holddown part 20A has a holding tab 20Aa that projects inward from a body that is screwed. The diffuser 15a is pressed by edge areas of the holding tabs 20Aa from the front-surface side. The liquid crystal panel 11 is placed on the holding tabs from the front-surface side and held between the bezel 13 and the holding tabs 20Aa. Cushion materials 20Ab for the liquid crystal panel 11 are arranged on surfaces of the holding tabs 20Aa.

The long-side holddown parts 20B and 20C are configured differently. The first long-side holddown parts 20B are arranged on the lower side of the chassis 14 in FIG. 3 (the lower side in the vertical direction). As illustrated in FIG. 3, three first long-side holddown parts 20B are arranged at substantially equal intervals. One of them is arranged around the middle of the long-side area of the chassis 14 on the lower side in FIG. 3 and the other two are arranged on either side of the one arranged in the middle. They are placed on the outer edge area of the first long-side support part 19B and screwed. As illustrated in FIG. 7, each first long-side holding part 20B has a holding tab 20Ba on the inner side similar to the short-side holding parts 20A. A surface of the holding tab 20Ba on the rear-surface side presses the diffuser 15a. Surfaces on the front-surface side receive the liquid crystal display panel 11 via cushion materials 20Bb. The first long-side holddown parts 20B has widths larger than those of the other holddown parts 20A and 20C so as to correspond to the first long-side support parts 19B. Protrusions 20Bc for positioning the first long-side holddown parts 20B to the first long-side support parts 19B are formed on the surfaces of the first long-side holddown parts 20B on the rear-surface side.

The second long-side holddown parts 20C are arranged on the upper side of the chassis 14 in FIG. 3 (the upper side in the vertical direction). As illustrated in FIG. 3, two second long-side holddown parts 20C are eccentrically arranged in a long-edge area of the chassis 14 on the upper side in FIG. 3. They are directly placed on the support plate 14c of the chassis 14 and screwed. As illustrated in FIG. 8, each second long-side holddown part 20C has a holding tab 20Ca on the inner side, similar to the short-side holddown parts 20A and the first long-side holing parts 20B. Surfaces of the holding tabs 20Ca on the rear-surface side press the diffuser 15a and the surfaces on the front-surface side receive the liquid crystal panel 11 via cushion materials 20Cb. Other cushion materials 20Cc are provided between the holding tabs 20Ca of the second long-side holddown parts 20C and the bezel 13.

The heat sinks 21 are made of synthetic resin or metal having high thermal conductivity and formed in a sheet-like shape. As illustrated in FIGS. 5 and 7, the heat sinks 21 are arranged inside and outside the chassis 14, respectively. The heat sink 21 inside the chassis 14 is placed between the bottom plate 14a of the chassis 14 and the LED boards 17. It has cutouts for the components in some areas. The heat sink 21 outside the chassis 14 is attached to the rear surface of the bottom plate 14a of the chassis 14.

As illustrated in FIG. 10, the LEDs 16 are surface-mounted to the LED boards 17, that is, the LEDs 16 are surface-mount LEDs. Each LED 16 has a block-like overall shape that is long in the horizontal direction. The LEDs 16 are side emitting LEDs. Aside surface of each LED 16 that stands upright from a mounting surface is a light emitting surface 16a. The mounting surface is placed against the LED board 17 (i.e., the bottom surface that is in contact with the LED board 17). A light axis LA of light emitted from the LED 16 is substantially parallel to the display surface 11a of the liquid crystal display panel 11 (the light exit surface 36 of the light guide plate 18) (see FIGS. 7 and 10). Specifically, the light axis LA of the light emitted from the LED 16 matches the short-side direction (the Y-axis direction) of the chassis 14, that is, the vertical direction. The light travels toward the upper side in the vertical direction (a travel direction of the outgoing light from the light exit surface 16a) (see FIGS. 3 and 7). The light emitted from the LED 16 three-dimensionally radiates around the light axis LA in a specified angle range. The directivity thereof is higher than cold cathode tubes. Namely, angle distributions of the LED 16 shows a tendency that the emission intensity of the LED 16 is significantly high along the light axis LA and sharply decreases as the angle to the light axis LA increases. The longitudinal direction of the LED 16 matches the long-side direction of the chassis 14 (the X-axis direction).

The LED 16 includes a plurality of LED chips 16c mounted on a board 16b that is arranged on an opposite side from the light emitting surface 16a (the rear-surface side). The LED chips 16c are light emitting components. The LED 16 is housed in the housing 16d and an inner space of the housing 16d is closed with a resin member 16e. The LED 16 includes three different kinds of the LED chips 16c with different main emission wavelengths. Specifically, each LED chip 16c emits a single color of light of red (R), green (G) or blue (B). The LED chips 16c are arranged parallel to each other along the longitudinal direction of the LED 16. The housing 16d is formed in a drum-like shape that is long in the horizontal direction and in white that provides high light reflectivity. The rear surface of the board 16b is soldered to a land on the LED board 17.

Each LED board 17 is made of synthetic resin and the surfaces thereof (including a surface facing the light guide plate 18) are in white that provides high light reflectivity. As illustrated in FIG. 3, the LED board 17 is formed in a plate-like shape having a rectangular plan view. The LED board 17 has a long dimension smaller than the short dimension of the bottom plate 14a and thus it can partially cover the bottom plate 14a of the chassis 14. The LED boards 17 are in a plane arrangement in a grid pattern on the surface of the bottom plate 14a of the chassis 14. In FIG. 3, five along the long-side direction of the chassis 14 by five along the short-side direction and a total of 25 LED boards 17 are arranged parallel to each other. Wiring patterns that are metal films are formed on each LED board 17 and the LEDs 16 are mounted in predetermined locations on the LED board 17. The LED boards 17 are connected to an external control board, which is not illustrated in the figures. The control board is configured to feed currents for turning on the LEDs 16 and to perform driving control of the LEDs 16. A number of LEDs 16 are arranged in a planar grid pattern on each LED board 17. The arrangement pitch of the LEDs 16 corresponds to the arrangement pitch of the light guide plates 18, which will be explained later. In other words, a number of the LEDs 16 are horizontally and vertically arranged on the LED bard 17 (FIG. 17). Specifically, eight along the long-side direction of the LED board 17 by four along the short-side direction thereof and a total of 32 LEDs 16 are arranged parallel to each other on the LED board 17. Photo sensors 22 are also mounted on the respective LED boards 17. Light emitting conditions of the LEDs 16 are determined by the photo sensors 22 and thus feedback control can be performed on the LEDs 16 (see FIGS. 4 and 11). Each LED board 17 has mounting holes 17a for receiving the clips 23 for mounting the light guide plates 18 (see FIG. 6). It also has positioning holes 17b for positioning the light guide plates 18 (see FIG. 10). The mounting holes 17a and the positioning holes 17b are formed in locations corresponding to mounting locations of the light guide plates 18. The mounting holes 17a and the positioning holes 17b are horizontally and vertically arranged (FIG. 17) similar to the light guide plates 18 and the LEDs 16.

Each light guide plate 18 is made of substantially transparent (i.e., having high light transmission capability) synthetic resin (e.g. polycarbonate), a reflective index of which is significantly higher than that of air. As illustrated in FIGS. 7 to 9, the light guide plate 18 draws the rays of light emitted from the LED 16 in the vertical direction (the Y-axis direction), and the rays of light travel through the light guide plate 18 to be directed toward the optical member 15 (in the Z direction). As illustrated in FIG. 11, the light guide plate 18 has a plate-like shape having a rectangular overall plan view. The long-side direction of the light guide plate 18 is parallel to the light axis LA of the LED 16 (the light emitting direction) and the short-side direction of the chassis 14 (the Y-axis direction or the vertical direction). The short-side direction is parallel to the long-side direction of the chassis 14 (the X-axis direction or the horizontal direction). Next, a cross-sectional structure of the light guide plate 18 along the long-side direction will be explained in detail.

As illustrated in FIGS. 7 to 9, the light guide plate 18 has a board mounting portion 30 that is located at one of end portions of the long dimension (on the LED 16 side) and attached to the LED board 17. The other end portion of the long dimension is configured as a light exit portion 31 from which light exits toward the diffusers 15a and 15b. The middle portion between the board mounting portion 30 and the light exit portion 31 is configured as a light guide portion 32. The light guide portion 32 is configured to direct the light to the light exit portion 31 without losing most of the light. Namely, the board mounting portion 30 (LED 16), the light guide portion 32 and the light exit portion 31 are arranged in this order from the LED 16 side along the long-side direction of the light guide plate 18, that is, along the light axis LA (the light emitting direction) of the LED 16. The board mounting portion 30 and the light guide portion 32 are non-luminous portions. The light exit portion 31 is a luminous portion. In the following description, a point ahead in a direction from the board mounting portion 30 toward the light exit portion 31 (the light emitting direction of the LED 16 or the direction toward right in FIGS. 7 to 9) is referred to as the front. A point behind in a direction from the light exit portion 31 toward the board mounting portion 30 (the direction toward left in FIGS. 7 to 9) is referred to as the rear.

In front of the board mounting portion 30, an LED holding space 33 for receiving the LED 16 therein is formed so as to run through in the Z-axis direction. A surface of one of inner walls of the LED holding space 33, which faces the light emitting surface 16a of the LEC 16 (i.e., the front surface), is a light entrance surface 34 through which light from the LED 16 enters. The light entrance surface 34 is located between the board mounting portion 30 and the light guide portion 32. About entire peripheries of the light guide portion 32 are flat and smooth surfaces. Scattered reflections do not occur at interfaces between the surfaces and external air layers AR1. Incident angles of light that strikes the interfaces are larger than a critical angle and thus the light is totally reflected at multiple times while traveling through the light guide portion 32 and guided to the light exit portion 31. Therefore, the light is less likely to leak from the light guide portion 32 and reach other light guide plates 18. In other words, because the light is less likely to leak from the light guide portion 32, the rays of light emitted from the LED 16 are guided to the light exit portion 31 without any loss. This sufficiently ensures the amount of rays of light exiting from the light exit surface 36 and improved brightness is obtained. The LED chips 16c of the LED 16 emits rays of light in respective RGB colors. Three different colors of the rays are mixed as the rays of light travel through the light guide portion 32 and turn into white. The white light is guided to the light exit portion 31. Since the rays of light are sufficiently diffused in the X-axis direction and the Y-axis direction while traveling through the light guide portion 32, the uniform in-plane brightness distribution can be achieved on the light exit surface 36. Furthermore, positioning protrusion 35 protrudes toward the rear-surface side. It is located in an area of the light guide portion 32 close to the board mounting portion 30 (close to a rear-end area). The light guide plate 18 is positioned with respect to the LED board 17 in the X-axis direction and the Y-axis direction when the protrusion 35 is inserted in the positioning hole 17b of the LED board 17.

A surface of the light exit portion 31 which faces toward the front-surface side is about an entire area of the surface opposite the diffuser 15b is a light exit surface 36. The light exit surface 36 is a substantially flat and smooth surface. It is substantially parallel to the plate surfaces of the diffusers 15a and 15b (or the display surface 11a of the liquid crystal display panel 11) and substantially perpendicular to the light entrance surface 34. The surface of the light exit portion 31 on the rear-surface side (the surface opposite from the light exit surface 36 or the surface facing the LED board 17) is processed so as to form microscopic asperities thereon. The surface with microscopic asperities is a scattering surface 37 that scatters light at the interface. The light that travels through the light guide plate 18 is scattered by the interface of the scattering surface 37. Namely, light rays strike the light exit surface 36 at the incident angles smaller than the critical angle (light rays that break the total reflection) and exit through the light exit surface 36. The scattering surface 37 has a plurality of lines of perforations 37a that extend straight along the short-side direction of the light guide plate 18 and parallel to each other. The arrangement pitch (the arrangement interval) of the perforations 37a is larger on the rear-end side of the light exit portion 31 than on the front-end side and gradually decreases (FIG. 12). Namely, the density of the perforations 37a of the scattering surface 37 is low on the rear-end side and that is high on the front side. The closer to the LED 16 the lower the density becomes, and the farther from the LED 16 the higher the density becomes, that is, the perforations 37a formed in a gradational arrangement. With this configuration, brightness in the area of the light exit portion 31 closer to the LED 16 is less likely to differ from brightness in the area of the light exit portion 31 father from the LED 16. As a result, the uniform in-plane brightness distribution can be achieved on the light exit surface 36. The scattering surface 37 is provided in the about entire area of the light exit portion 31. The entire area substantially overlaps the light exit surface 36 in the plan view.

A reflection sheet 24 is placed on surfaces of each light exit portion 31 and each light guide portion 32 (including the scattering surface 37) on the rear-surface side. Light reflects off the reflection sheet 24 to be directed into the light guide plate 18. Each reflection sheet 24 is made of synthetic resin and the surface thereof is white that provides high light reflectivity. The reflection sheet 24 is disposed so as to cover about entire areas of the light exit portion 31 and the light guide portion 32 in the plan view as illustrated in FIG. 12. With the reflection sheet 24, the light that travels through the light guide plate 18 does not leak to the rear-surface side and the light that is scattered at the scattering surface 37 is effectively directed toward the light exit surface 36. The reflection sheet 24 is attached separately to each light guide plate 18. Each of the reflection sheets 24 that are attached to the horizontally or vertically adjacent light guide plates 18 is separated from each other. The side-edge surfaces (the side-edge surfaces in the horizontal direction) and the front-end surface of each reflection sheet 24 are on the substantially same plane as the side-edge surfaces and the front-end surface of each light guide plate 18. The rear-side end of the reflection sheet 23 is located between the light entrance surface 34 and the positioning protrusion 35 of the light guide plate 18. The reflection sheet 24 is attached to the light guide plate 18 with transparent adhesives at points in side edge areas that are less likely to interfere with light that travels through the light guide plate 18. The reflection sheet 24 has holes through which the positioning protrusions 35 are passed. The side-edge surfaces and the front-end surface (distal-end surface) of each light exit portion 31 are flat and smooth surfaces similar to those of the light guide portion 32. Therefore, light is less likely to leak.

As illustrated in FIG. 10, the light guide plate 18 has flat surfaces 38 and 41 on the front-surface side (the surface opposite the diffusers 15a and 15b, including the light exit surface 36) and on the rear-surface side (the surface opposite the LED board 17), respectively. The flat surfaces 38 and 41 are substantially parallel to the X-Y plane (or the display surface 11a). The light guide plate 18 also has sloped surfaces 39 and 40. Specifically, the surface of the board mounting portion 30 on the rear-surface side is a mounting surface that is placed on the LED board 17. To make the mounting condition stable, the flat surface 38 (the surface parallel to the main board surface of the LED board 17) is provided. The surfaces of the light guide portion 32 and the light exit portion 31 on the rear-surface side form a continuous sloped surface 39. The board mounting portion 30 of the light guide plate 18 is in contact with the LED board 17 and fixed. The light guide portion 32 and the light exit portion 31 are separated from the LED board 17, that is, they are not in contact with the LED board 17. The light guide plate 18 is held in a cantilever manner with the board mounting portion 30 on the rear side as an anchoring point (or a supporting point) and a front end as a free end.

The surfaces of entire parts of the board mounting portion 30 and the light guide portion 32 and a part of the light exit portion 31 close to the light guide portion 32 on the front-surface side form the continuous sloped surface 40. The sloped surface 40 is sloped at about the same angle and parallel with respect to the sloped surface 39 on the rear-surface side. Namely, the thickness of the light guide plate 18 is substantially constant in the entire light guide portion 32 and a part of the light exit portion 31 close to the light guide portion 32 (close to the LEE 16). The surface of the light exit portion 31 on the front side (away from the LED 16) on the front-surface side is the flat surface 41. Namely, the light exit surface 36 includes the flat surface 41 and the sloped surface 40. Most part of the light exit surface 36 on the front side is the flat surface 41 and a part thereof on the light guide portion 32 side is the sloped surface 40. The thickness of the board mounting portion 30 decreases toward the rear end (as further away from the light guide portion 32), that is, the board mounting portion 30 has a tapered shape. A part of the light exit portion 31 adjacent to the light guide portion 32 has the sloped surface 40 on the front-surface side and thus the thickness thereof is constant. A part of the light exit portion 31 located more to the front than the above part has the flat surface 41 on the front-surface side. Therefore, the thickness gradually decreases toward the front end (as further away from the light guide portion 32), that is, the light exit portion 31 has a tapered shape. A long dimension (a dimension measuring in the Y-axis direction) of the flat surface 41 on the front-surface side is smaller than that of the flat surface 38 on the rear-surface side. Therefore, the front-end area of the light exit portion 31 is smaller in thickness than the rear-end area of the board mounting portion 30. Moreover, a surface area of the front-end area (distal-end area) of the light exit portion 31 is smaller than that of the rear-end area of the board mounting portion 30. All peripheral surfaces of each light guide plate 18 (including side surfaces and a front surface) are vertically straight surfaces along the Z-axis direction.

As illustrated in FIG. 11, each light guide plate 18 having the above cross sectional structure has a pair of the LED holding spaces 33 for holding the LEDs 16. The light guide plate 18 is configured to receive rays of light from two different LEDs 16 and guide them to the diffusers 15a and 15b in optically independent conditions. The light guide plate 18 will be explained in detail together with a planar arrangement of the components of the light guide plate 18.

The light guide plate 18 has a symmetric shape with a line that passes through the middle of the short side (in the X-axis direction) as a line of symmetry. The LED holding spaces 33 of the board mounting portion 30 are arranged symmetrically a predetermined distance away from the middle of the short side (in the X-axis direction) of the light guide plate 18. Each LED holding space 33 has a landscape rectangular shape in plan view and a size slightly larger than an overall size of the LED 16. The height (the dimension measuring in the Z-axis direction) and the width (the dimension measuring in the X-axis direction) are slightly larger than those of the LED 16. The surface area of the light entrance surface 34 is significantly larger than the light exit surface 16a. Therefore, the rays of light emitted radially from the LED 16 enter the light guide plate 18 without any loss.

As illustrated in FIG. 11, the LED 16 is arranged in the LED holding space 33 with entire peripheries thereof are separated from the inner walls of the LED holding space 33 (including the light entrance surface 34) by gaps in predetermined sizes. The gaps are provided for compensating for an error related to a mounting position of the light guide plate 18 with respect to the LED board 17. The gaps are required for allowing thermal expansion of the light guide plate 18, which may occur due to heat generated during lighting of the LED 16. By providing the gaps between the LED 16 and the walls of the LED holding space 33, the light guide plate 18 is less likely to touch the LED 16 and thus the LED 16 is protected from being damaged.

At the middle of a short dimension of the light guide plate 18, a slit 42 is formed so as to divide the light guide portion 32 and the light exit portion 31 into right and left. The slit 42 runs through the light guide plate 18 in the thickness direction (the Z-axis direction) and toward the front along the Y-axis direction with a constant width. The slit 42 equally divides the light guide portion 32 into a pair of divided light guide portions 32S and equally divides the light exit portion 31 and the light exit surface 36 into a pair of divided light exit portions 31S and a pair of divided light exit surfaces 36S respectively. Edge surfaces of the light guide plate 18, which face the slit 42, form side-edge surfaces of the divided light guide portion 32S and the divided light exit portion 31S. Each side-edge surface includes a flat surface that is substantially straight along the Z-axis direction. The rays of light passing through the light guide plate 18 totally reflect off an interface between the light guide plate 18 and the air layer AR2 in the slit 42. Therefore, the rays of light do not travel or mix together between the divided light guide portions 32S that faces each other via the slit 42 or between the divided light exit portions 31S that faces each other via the slit 42. The divided light guide portions 32S and the divided light exit portions 31A are optically independent from each other. A dimension (width) of the slit 42 in the X-axis direction (the horizontal direction) is set so as to ensure the air layers AR2 with compensating for a manufacturing error of the light guide plates 18 and the extension amount of the light guide plates 18 due to thermal expansion.

The rear end of the slit 42 is slightly more to the front than the positioning protrusion 35 and more to the rear than a lighting area of each LED 16 in the X-axis direction (the area within an angular range with the light axis LA of the LED 16 as the center and indicated by alternate long and short dash lines in FIG. 12). With this configuration, the rays of light emitted from the LED 16 do not directly enter the adjacent divided light guide portion 32S that is not a target to be lit. The positioning protrusions 35 are symmetrically located on the outer end areas of the divided light guide portions 32S (the end portions away from the slit 42) more to the rear than the lighting areas of the respective LEDs 16 with respect to the X-axis direction. Therefore, the positioning protrusions 35 are less likely to be obstacles in optical paths. The slit 42 does not run to the board mounting portion 30. Therefore, the divided light guide portions 32S connect to each other and continue into the board mounting portion 30. This provides mechanical stability in mounting conditions. The light guide plate 18 includes two unit light guide plates (corresponding to the divided light guide portion 32S and the divided light exit portion 31S). The unit light guide plates are optically independent from each other and provided each for each LED 16. The unit light guide plates are connected to each other together with the board mounting portion 30. This simplifies mounting of the light guide plate 18 to the LED board 17. The reflection sheet 24 is placed over the slit 42 and provided on the rear-surface side (a side opposite from the light exit side) with respect to the air layer AR2 in the slit 42 (FIG. 12).

Clip insertion holes 43 are formed in the side-edge areas of the board mounting portion 30 (in the areas more to the outsides than the LED holding space 33). The clip mounting holes 43 are through holes provided for mounting the light guide plate 18 to the LED board 17. As illustrated in FIG. 6, each clip 23 includes amounting plate 23a, an insertion post 23b and a pair of stoppers 23c. The mounting plate 23a is parallel to the board mounting portion 30. The insertion post 23b projects from the mounting plate 23a in the thickness direction (the Z-axis direction) of the board mounting portion 30. The stoppers 23c project from an end of the insertion post 23b so as to return toward the mounting plate 23a. The insertion post 23b of the clip 23 is inserted in the clip insertion hole 43 of the board mounting portion 30 and the mounting hole 17a of the LED board 17. The stoppers 23c of the clip 23 are held to the edge portions around the mounting hole 17a. As a result, the light guide plate 18 is mounted and fixed to the LED board 17. As illustrated in FIGS. 5 and 13, one kind of the clips 23 has a single insertion post 23b projecting from the mounting plate 23a and the other kind has two insertion posts 23b projecting from the mounting plate 23a. The first kind of the clips 23 are inserted in the clip insertion holes 43 located in the end areas inside the chassis 14. The other kind of the clips 23 are arranged so as to connect two light guide plates 18 that are parallel to each other and thus the two light guide plates 18 are collectively mountable. As illustrated in FIGS. 6 and 11, clip receiving recesses 44 for receiving the mounting plates 23a of the clips 23 are provided around the clip insertion holes 43. With the clip receiving recesses 44, the mounting plates 23a do not project from the board mounting portions 30 toward the front and thus spaces can be reduced, that is, the thickness of the backlight unit 12 can be reduced. The clips 23, the clip insertion holes 43 in the light guide plates 18 and the mounting holes 17a in the LED board 17 form a fixing structure of the light guide plates 18 with respect to the LED board 17.

As illustrated in FIG. 11, each board mounting portion 30 has a photo sensor holding space 45 between the LED holding spaces 33. The photo sensor holding space 45 is a through hole for holding the photo sensor 22 mounted on the LED board 17. A predetermined number of the photo sensors 22 are arranged irregularly, that is, between specific LEDs on the LED boards 17. Namely, some photo sensor holding spaces 45 of the light guide plates 18 in the chassis 14 do not hold the photo sensors 22. Each board mounting portion 30 has cutouts 46 between the photo sensor holding space 45 and each of the LED holding spaces 33 on the board mounting portion 30. The cutouts 46 are located symmetrically. Each cutout 46 runs completely through the board mounting portion 30 similar to the LED holding portion 33 but opens on the rear end. A screw (not shown) for fixing the LED board 17 to the chassis 14 is inserted in the cutout 46. Some of the cutouts are not used for light guide plates 18 in the chassis 14, as some photo sensor holding spaces 45 are not used.

As described above, a large number of the light guide plates 18 are placed in a grid and in a planar arrangement within the area of the bottom plate 14a of the chassis 14. The arrangement of the light guide plates 18 will be explained in detail. First, the arrangement in the tandem-arrangement direction (the Y-axis direction) that is the vertical direction will be explained. As illustrated in FIG. 9, the light guide plates 18 are mounted such that the light guide portions 32 and the light exit portions 31 are separated from the LED boards 17. The light guide portion 32 and the light exit portion 31 of each light guide plate 18 overlap about entire areas of the board mounting portion 30 and the light guide portion 32 of the adjacently located light guide plate 18 on the front side (the upper side in the vertical direction) from the front side. Namely, the board mounting portion 30 and the light guide portion 32 of the light guide plate 18 on the front side overlap the light guide portion 32 and the light exit portion 31 of the light guide plate 18 on the rear side in the plan view. The board mounting portion 30 and the light guide portion 32, which are the non-luminous portion of the light guide plate 18, are covered with the light guide portion 32 and the light exit portion 31 of the adjacent rear light guide plate 18. Namely, the board mounting portion 30 and the light guide portion 32 are not bare on the diffuser 15b side and only the luminous portion, that is, the light exit surface 36 of the light exit portion 31 is bare. With this configuration, the light exit surfaces 36 of the light guide plates 18 are continuously arranged without gaps in the tandem-arrangement direction.

About entire rear surfaces of the light guide portion 32 and the light exit portion 31 are covered with the reflection sheet 24. Therefore, even when light is reflected by the light entrance surface 34 and light leak occurs, the leak light does not enter the adjacent light guide plate 18 on the rear side. Furthermore, the reflection sheet 24 attached to the rear-side light guide plate 18 is provided between the overlapping portions of the adjacent light guide plates 18 in the tandem-arrangement direction. The rays of light do not travel or mix together between the overlapping portions. The light guide portion 32 and the light exit portion 31 of the light guide plate 18 on the rear side (the front-surface side) is mechanically supported by the adjacent overlapping light guide plate 18 on the front side (the rear-surface side) from the rear side. The sloped surface 40 of the light guide plate 18 on the front-surface side and the sloped surface 39 on the rear-surface side have substantially same slope angles and are parallel to each other. Therefore, gaps are not created between the overlapping light guide plates 18 and the light guide plates 18 on the rear-surface side support the light guide plates 18 on the front-surface side without rattling. Only front-side parts of the light guide portions 32 of the light guide plates 18 on the rear side cover the board mounting portions 30 of the light guide plates 18 on the front side. The rear-side parts face the LED boards 17.

The arrangement in a direction perpendicular to the tandem-arrangement direction that is the horizontal direction (the X-axis direction) is illustrated in FIGS. 5 and 13. The light guide plates 18 do not overlap each other in the plan view. They are arranged parallel to each other with predetermined gaps (clearance) therebetween. With the gaps, air layers AR1 are provided between the light guide plates 18 adjacent to each other in the horizontal direction. Therefore, the rays of light do not travel or mix between the light guide plates 18 adjacent to each other in the horizontal direction and thus the light guide plates 18 are optically independent from each other. The size of the gaps between the light guide plates 18 is equal to or smaller than that of the slit 42. The gaps between the light guide plates 18 are set so as to sufficiently ensure the air layers AR1 with compensating for an error related to a mounting position of the light guide plate 18 with respect to the LED board 17 and the extension amount of the light guide plates 18 due to thermal expansion.

As illustrated in FIGS. 3 and 13, a large number of the light guide plates 18 are arranged in the planar arrangement inside the chassis 14. The light exit surface of the backlight unit 12 is formed with a number of the divided light exit portions 31S (the divided light exit surfaces 36S). As described above, the divided light guide portions 32s and the divided light exit portions 31S of the light guide plates 18 are optically independent from each other. Turning on and off of the LEDs 16 are controlled independently. The outgoing light (amounts of light, emission or non-emission of light) from the divided light exit portion 31S can be controlled independently. The driving of the backlight unit 12 can be controlled using an area active technology that provides control of outgoing light for each area. This significantly improves contrast that is very important for display performance of the liquid crystal display device 10.

As illustrated in FIG. 13, the horizontally adjacent light guide plates 18 (that are arranged in a direction parallel to the light exit surface 36 and perpendicular to the arrangement direction of the LEDs 16 and the light entrance surfaces 34) are arranged with having gaps C1 (clearance) in predetermined sizes therebetween to ensure the air layers AR1. Light is less likely to leak directly from the light guide plate 18 into the gap C1 areas. The light guide portions 32 that are the non-luminous portions of the light guide plates 18 that are provided to relatively overlap on the rear-surface side are bare to the outside from the gap C1 areas (FIG. 15). Therefore, the amount of rays of light exiting from the gap C1 areas is relatively small compared to that exiting from the light exiting surfaces 36 and this may cause dark points.

The gap C2 in the slit 42 is provided between the horizontally adjacent divided light guide portions 32 and between the horizontally adjacent divided light exit portions 31 to ensure the air layer AR2. The rays of light are less likely to leak directly from the light guide plate 18 into the gap C2 areas. The reflection sheet 24 is provided to bare to outside from the gap C2 areas (FIG. 16). Therefore, if the rays of light strike other member such as the optical member 15 and return to the gap C2 areas, the returned rays of light reflect off the bare reflection sheet 24 again and exit to the front-surface side. Accordingly, the amount of rays of light exiting from the gap C2 areas may exceed the amount of rays of light exiting from the light exit surfaces 36. In such a case, the bright points may be caused. The amount of rays of light exiting from the gap C2 areas may be smaller than that exiting from the light exit surfaces 36. In such a case, the gap C2 areas may be dark points. In either of the cases, the rays of light entering the gap C2 reflect off the reflection sheet 24 to be directed to the front-surface side and effectively used. This is preferable to improve brightness of the backlight unit 12.

As described before, the amount of rays of light is relatively different in the gap C1 areas and the gap C2 areas compared to the amount of rays of light exiting from the light exit surfaces 36. This may cause uneven brightness on the light exit surface of the backlight unit 12. In the present embodiment, the light guide plates 18 are arranged such that the gaps C1, C2 (the air layers AR1, AR2) of the horizontally adjacent light guide plates 18 are positioned to be offset from each other in the horizontal direction. Accordingly, the gap C1 areas and the gap C2 areas that have the different amount of rays of light exiting therefrom with respect to the light exiting surfaces 36 are less likely to be recognized. Specific arrangement of the light guide plates 18 will be explained below.

As illustrated in FIGS. 3 and 13, a number of the light guide plates 18 are arranged parallel to each other in the horizontal direction in a predetermined arrangement pattern AP1 or AP2 to form a set of horizontally-arranged light guide plates 18. A number of sets of the horizontally-arranged light guide plates 18 are arranged parallel to each other in the vertical direction. Accordingly, the light guide plates 18 are arranged in a substantially grid pattern. The positions of the light guide plates 18 arranged in the arrangement pattern AP1 are offset from those in the arrangement pattern AP2 by a predetermined distance in the horizontal direction. The arrangement patterns AP1 and AP2 are arranged alternately in the vertical direction. Namely, the light guide plates 18 are arranged in a regular manner in the horizontal direction and the vertical direction.

Specifically, the arrangement pattern of a set of horizontally-arranged light guide plates 18 that is located at the upper side (the front side) in FIG. 13 is referred to as an arrangement pattern AP1. The arrangement pattern of a set of horizontally-arranged light guide plates 18 that is located at a loser side (a rear side) of the first arrangement pattern AP1 in FIG. 13 is referred to as an arrangement pattern AP2. The gap C1 between the light guide plates 18 in the first arrangement pattern AP1 has a substantially same width W2 in the horizontal direction as the gap C1 between the light guide plates 18 in the second arrangement pattern AP2. The specific width W2 is 1 mm for example. Each light guide plate 18 in the first arrangement pattern AP1 and each light guide plate 18 in the second arrangement pattern AP2 are arranged in offset positions (are offset from each other) by a predetermined distance W1 in the horizontal direction. Accordingly, each gap C1 between the light guide plates 18 in the first arrangement pattern AP1 and each gap C1 between the light guide plates 18 in the second arrangement pattern AP2 are offset from each other by the predetermined distance W1, and also each gap C2 of the slits 42 in the light guide plates 18 in the first arrangement pattern AP1 and each gap C2 of the slits 42 in the second arrangement pattern AP2 are offset from each other by the predetermined distance W1. A set of the light guide plates 18 of the first arrangement pattern AP1 and a set of the light guide plates of the second arrangement pattern AP2 are alternately arranged in the vertical direction (the Y-axis direction). Sets of the light guide plates 18 of the same arrangement pattern are not arranged in adjacent to each other in the vertical direction. In other words, a set of the light guide plates 18 next to the set of the light guide plates 18 of the first arrangement pattern AP1 is necessarily arranged in the second arrangement pattern AP2, and a set of the light guide plates 18 next to the set of light guide plates 18 of the second arrangement pattern AP2 is necessarily arranged in the first arrangement pattern AP1. Accordingly, each gap C1, C2 and each air layer AR1, AR2 of the light guide plates 18 of the first arrangement pattern AP1 and each gap C1, C2 and each air layer AR1, AR2 of the light guide plates 18 of the second arrangement pattern AP2 are arranged in a zigzag arrangement in a plane along the light exit surface 36 (in an X-Y plane). They are offset from each other in the horizontal direction and are not continuously arranged in the vertical direction. In FIG. 13, due to space restriction on a paper, only four light guide plates 18 are arranged in the vertical direction.

The light guide plate 18 (the gap C1, C2, the air layer AR1, AR2) of the first arrangement pattern AP1 is offset from the light guide plate 18 (the gap C1, C2, the air layer AR1, AR2) of the second arrangement pattern AP2 in the horizontal direction by the distance W1 (distance in the horizontal direction). The distance W1 is set as follows. As illustrated in FIG. 14, the distance W1 is sufficiently greater than the horizontal dimension W2 of the gap C1 between the horizontally adjacent light guide plates 18 and the horizontal dimension W2 of the gap C2 of the slit 42. Therefore, the gaps C1, C2 (the air layers AR1, AR2) in the adjacent sets of horizontally arranged light guide plates 18 are surely far from each other in the horizontal direction. This keeps the gaps C1, C2 (the air layers AR1, AR2) from being connected to each other continuously in the vertical direction.

In the tandem arrangement, the light guide plates 18 are arranged in series in a front-rear direction. In the following, for simple explanation, the ones that are arranged at the uppermost side (front side) in FIG. 13 are first light guide plates 18A, and the ones that are arranged on the relatively lower side (rear side) in FIG. 13 with respect to the first light guide plates 18A and partially overlap the first light guide plates 18A on the front-surface side (the side opposite from the LED board 17, the light exit side) are second light guide plates 18B, and the ones that are arranged on the relatively lower side in FIG. 13 with respect to the second light guide plate 18B and partially overlap the second light guide plate 18B on the front-surface side are third light guide plates 18C. In such a case, the first light guide plates 18A and the third light guide plates 18C are arranged in the first arrangement pattern AP1, and the second light guide plates 18B are arranged in the second arrangement pattern AP2. In FIGS. 15 and 16, the symbols 18A, 18B and 18C are used for referring to the first light guide plate, the second light guide plate and the third light guide plate, respectively. To refer to the light guide plate 18 as a whole, the numeral 18 without the letters is used.

The offset distance W1 is set as follows. As illustrated in FIG. 14, the offset distance W1 is set to be sufficiently smaller than a distance W3 from a side end (an end in the horizontal direction) of the light guide plate 18 to a side end of the LED 16. Accordingly, as illustrated in FIG. 13, the second light guide plate 18B and the reflection sheet 24 of the second arrangement pattern AP2 surely overlap the LED 16 on the relatively front-surface side. The LED 16 is provided for the first light guide plate 18A of the first arrangement pattern AP1. With this configuration, the LED 16 is arranged so as not to be bare to the gap C1 between the second light guide plates 18B that are arranged in the horizontal direction and the rays of light emitting from the LED 16 do not directly enter the gap C1. Furthermore, as illustrated in FIG. 14, the offset distance W1 is set to be slightly smaller than a distance W4 from the side end of the light guide plate 18 to the side end of the LED holding space 33. Accordingly, the LED holding space 33 of the first light guide plate 18A of the first arrangement pattern AP1 is surely closed from the front-surface side by the second light guide plate 18B and the reflection sheet 24 of the second arrangement pattern AP2. The LED holding space 33 is not provided above the gap C1 between the second light guide plates 18B that are arranged in the horizontal direction and the rays of light do not directly enter the gap C1 from the LED holding space 33. Difference between the offset distance W1 and the distance W3 and difference between the offset distance W1 and the distance W4 are set to be greater than error difference in the horizontal direction related to mounting of the light guide plates 18 to the LED board 17.

Further more, the third light guide plate 18C is arranged with respect to the LED 16 provided for the first light guide plate 18A as follows. As illustrated in FIGS. 14 to 16, the third light guide plate 18C is arranged such that the front end thereof overlaps the LED 16 provided for the first light guide plate 18A relatively on the front-surface side. The second light guide plate 18B and the reflection sheet 24 thereof are provided between the third light guide plate 18C and the LED 16 provided for the first light guide plate 18A. Accordingly, the LED 16 is not bare on the front-surface side. The LED 16 provided for the first light guide plate 18A overlaps the second light guide plate 18B and the reflection sheet 24 thereof and also overlaps the third light guide plate 18C and the reflection sheet 24 thereof.

The light guide plates 18 are thus arranged on the LED board 17. Mounting holes 17a that are fixing structures of the LED 16 as a light source and the light guide plate 18 are formed on the LED board 17 so as to correspond to the arrangement of the light guide plates 18. Specifically, as illustrated in FIG. 17, the LEDs 16 and the mounting holes 17a are provided on the LED board 17 corresponding to the first arrangement pattern AP1 and the second arrangement pattern AP2. Namely, the LEDs 16 and the mounting holes 17a provided corresponding to the first arrangement pattern AP1 are offset from those provided corresponding to the second arrangement pattern AP2 by the offset distance W1 in the horizontal direction. In other words, the LEDs 16 and the mounting holes 17a are arranged in the zigzag arrangement similar to the light guide plates 18. The positioning holes 17b for positioning the light guide plates 18 on the LED board 17 are similarly arranged in the zigzag arrangement. Thus, the light guide plates 18 of the first arrangement pattern AP1 and the light guide plates 18 of the second arrangement pattern AP2 have the same structure and common parts are used.

The light guide plates 18 having the above-mentioned structure are mounted on the LED board 17 in the manufacturing process of the backlight unit. The LEDs 16 are mounted on the LED board 17. Specifically, each LED board 17 is attached to the bottom plate 14a of the chassis 14 in a predetermined position (FIG. 3), and then the light guide plate 18 is mounted in a position corresponding to each LED 16 of each LED board 17. In such a case, the light guide plate 18 is mounted in a position corresponding to the LEDs 16 at an upper end position (a front end position) in the vertical direction (the tandem-arrangement direction, Y-axis direction) on the bottom plate 14a of the chassis 14. Then, the light guide plates 18 are sequentially mounted in positions corresponding to the LEDs 16 at a lower side (rear side) in the vertical direction (FIGS. 7 to 9). The light guide plates 18 mounted secondarily and later in the vertical direction partially overlap the adjacent light guide plate 18 at the upper side (the front side) in the vertical direction on the front-surface side. Accordingly, the light guide plates 18 are arranged in the tandem arrangement along the vertical direction with overlapping each other.

In the mounting operation, the light guide plates 18 are arranged in a regular manner as mentioned before and the minimum two different types of horizontal arrangement patterns AP1, AP2 of the light guide plates 18 are alternately arranged. Therefore, the mounting positions of the light guide plates 18 that are sequentially mounted in the vertical direction (the tandem-arrangement direction) are provided in a simplified zigzag arrangement. Accordingly, the mounting operation is executed effectively. Furthermore, the reflection sheet 24 is provided on each of the light guide plates 18 independently. Each light guide plate 18 is handled independently and has good handling properties.

After the light guide plates 18 are mounted to the LED board 17 as described before, other components are mounted thereto to complete the assembling of the backlight unit 12 and the liquid crystal display device 10. Power of the liquid crystal display device 10 is turned on to light each LED 16. Rays of light emitting from the light emitting surface of each LED 16 strike the light entrance surface 34. The rays of light guided from the light entrance surface 34 into the light guide plate 18 are totally reflected at interfaces with the air layers AR1, AR2 while traveling through the light guide portion 32 and guided to the light exit portion 31. Therefore, the light is less likely to leak from the light guide portion 32. While traveling through the light guide portion 32, three different colors of the beams RGB from the LED chips 16c of the LED 16 are mixed as the beams of light travel through the light guide portion 32 and turn into white. The white light is dispersed sufficiently in the X-axis direction and the Y-axis direction. The light that travels through the light guide plate 18 and reaches the light exit portion 31 is scattered by the interface of the scattering surface 37 formed on the surface opposite from the light exit surface 36. Then, the light is reflected by the reflection sheet 24 provided on the rear side and directed to the light exit surface 36. Light beams scattered by the scattering surface 37 may be directed upwardly by the reflection sheet 24 and strike the light exit surface 36 at the incident angles smaller than the critical angle and exit through the light exit surface 36. Incident angles of light that strikes the light exit surface 36 are larger than a critical angle and thus the light is totally reflected by the light exit surface 36 and scattered by the scattering surface 37 at multiple times while traveling through the light guide portion 32 and exit from the light exit surface 36. The light exiting from the light guide plates 18 is equally dispersed in a plane of the light exiting surface 36 of the whole backlight unit 12 while traveling through the diffusers 15a, 15b and the optical sheet 15c. Finally, substantially planar light is obtained and irradiated to the liquid crystal panel 11.

As mentioned before, the light traveling through the light guide plate 18 is less likely to leak to the gap C1 (the air layer AR1) between the horizontally adjacent light guide plates 18 and the gap C2 (the air layer AR2) of the slit. Therefore, the amount of rays of light exiting from the gap C1 areas and the gap C2 areas necessarily differs from the amount of rays of light existing from the light exit surface 36 (the divided light exit surface 36S). This may cause uneven brightness. In the present embodiment, as illustrated in FIG. 13, the light guide plates 18 are arranged such that the gaps C1, C2 in a first set of the horizontally-arranged light guide plates 18 are arranged with being offset from the gaps C1, C2 in a second set of the light guide plates 18 that is next to the first set in the vertical direction. Therefore, the gap C1 areas and the gap C2 areas are not continuously provided in the vertical direction. The amount of rays of light exiting from the gap C1 areas and the gap C2 areas are different from the amount of rays of light exiting from the light exit surfaces 36. The gap C1 areas and the gap C2 areas do not extend linearly in the vertical direction. Therefore, the gap C1 areas and the gap C2 areas are less likely to be recognized as dark lines or bright lines.

Specifically, the light guide plates 18 arranged in the first arrangement pattern AP1 and the light guide plates 18 arranged in the second arrangement pattern AP2 that are offset from each other in the horizontal direction by the offset distance W1. The offset distance W1 is set to be greater than the horizontal dimension W2 of the gap C1, C2. Therefore, the gaps C1, C2 of the adjacent sets of the horizontally-arranged light guide plates 18 are arranged far from each other and independently from each other in the horizontal direction. Accordingly, the gaps C1, C2 of the adjacent sets of horizontally-arranged light guide plates are not continuously connected to each other in the vertical direction and arranged in a discontinuous arrangement. Therefore, the gap C1 areas and the gap C2 areas are less likely to be recognized. Furthermore, the offset distance W1 is set to be smaller than the distance W3 between the side end of the light guide plate 18 and the side end of the LED 16 or the distance W4 between the side end of the light guide plate 18 and the side end of the LED holding space 33. Therefore, the light guide plate 18 of a first set of the horizontally-arranged light guide plates 18 (the first light guide plate 18A) is provided to partially overlap the light guide plate 18 of a second set of the horizontally-arranged light guide plates 18 next to the first set (the second light guide plate 18B). Specifically, the second light guide plate 18B overlaps each LED 16 and each LED holding space 33 of the first light guide plate 18A on the front-surface side. Accordingly, the LEDs 16 and the LED holding spaces 33 are not bare to face the diffuser 15b on the front-surface side and the light from the LEDs 16 do not directly strike the diffuser 15b. Therefore, uneven brightness is less likely to be caused.

As explained before, the backlight unit 12 of the present embodiment includes the LEDs 16, the light guide plates 18 and the air layers AR1. Each light guide plate 18 includes the light entrance surface 34 and the light exit surface 36. The light entrance surface 34 is provided to face the LED 16 and light from the LED 16 strikes the light entrance surface 34. The light exit surface 36 is parallel to an arrangement direction in which the LED 16 and the light entrance surface 34 are arranged and the light exits from the light exit surface 36. The arrangement direction in which the LED 16 and the light entrance surface 34 are arranged is a vertical direction and a direction parallel to the light exit surface 36 and perpendicular to the arrangement direction is a horizontal direction. The light guide plates 18 are arranged in the vertical direction and in the horizontal direction. Each air layer AR1 has a reflective index lower than the light guide plate 18 and is provided between the horizontally adjacent light guide plates 18. A first set of the horizontally-arranged light guide plates 18 and a second set of the horizontally-arranged light guide plates 18 that is next to the first set are arranged such that the air layers AR1 between the light guide plates 18 of the first set are located in different positions in the horizontal direction from the air layers AR1 between the light guide plates 18 of the second set.

The rays of light emitting from the LED 16 and entering the light entrance surface 34 strike the interface between the air layer AR1 and the light guide plate 18. Accordingly, the rays of light totally reflect off the interface and effectively travel through the light guide plate 18 and are directed to and exit from the light exit surface 36. The rays of light traveling through the light guide plate 18 are less likely to leak to the air layers AR1 between the horizontally-arranged adjacent light guide plates 18. The amount of light exiting from the air layers AR1 may be significantly and relatively different from that exiting from the light exit surfaces 36. A first set of the horizontally-arranged light guide plates 18 and a second set of the horizontally-arranged light guide plates 18 that is next to the first set are arranged such that the air layers AR1 between the light guide plates 18 of the first set are located in different positions in the horizontal direction from the air layers AR1 between the light guide plates 18 of the second set. Accordingly, the air layers AR1 are not continuously connected in the vertical direction. The air layer AR1 areas having the amount of exiting light different from the amount of exiting light from the light exit surface 36 are less likely to be recognized as uneven brightness areas and uneven brightness is less likely to be caused.

The light guide plates 18 are arranged in the different horizontal arrangement patterns AP1, AP2. In each of the arrangement patterns AP1, AP2, the air layers AR1 (AR2) are located in different positions in the horizontal direction. The arrangement patterns AP1, AP2 are provided repeatedly in a predetermined order. Accordingly, the light guide plates 18 are arranged in a regular manner in the horizontal direction and in the vertical direction. This makes the assembling operation of the light guide plates 18 to be easier.

Two arrangement patterns AP1, AP2 are provided. The minimum two different types of horizontal arrangement patterns AP1, AP2 of the light guide plates 18 are provided. Compared to the case in that three or more arrangement patterns are provided, the mounting operation of the light guide plates 18 is simplified and easy to be executed.

The two different arrangement patterns AP1, AP2 of the light guide plates 18 are alternately arranged in the vertical direction. Accordingly, the same arrangement pattern is not arranged in the vertical direction next to each other. The air layers AR1 (AR2) are not continuously connected to each other in the vertical direction. Therefore, the air layers AR1 are less likely to be recognized and uneven brightness is less likely to be caused.

The LEDs 16 are arranged in the horizontal direction and in the vertical direction in the positions corresponding to the light entrance surfaces 34 of the light guide plates 18 of the arrangement patterns AP1, AP2. Accordingly, the LEDs 16 are arranged in the horizontal direction and in the vertical direction in the positions corresponding to the arrangement patterns AP1, AP2 of the light guide plates 18. Therefore, the arrangement of the light entrance surfaces 34 is same in every light guide plate 18. Accordingly, each of the light guide plate 18 used in each arrangement pattern AP1, AP2 has the same structure. This reduces the number of parts.

The LEDs 16 and the light guide plates 18 are mounted to the LED board 17. Fixing structures for fixing the light guide plates 18 to the LED board 17 are provided on the LED board 17 and the light guide plates 18. The mounting holes 17a that are the fixing structures on the LED board 17 are arranged in the vertical direction and in the horizontal direction in the positions corresponding to the light guide plates 18 arranged in the arrangement patterns AP1, AP2. Accordingly, the mounting holes 17a are arranged in the vertical direction and in the horizontal direction on the LED board 17 corresponding to the arrangement patterns AP1, AP2 of the light guide plates 18. Therefore, the arrangement of the fixing structures on each of the light guide plates 18 is same. Therefore, the light guide plates 18 used for the arrangement patterns AP1, AP2 are configured in the same structure, and this reduces the number of parts.

The reflection sheet 24 for reflecting rays of light toward the light exit surface 36 side is provided on a surface of the light guide plate 18 opposite from the light exit surface 36. Accordingly, the rays of light traveling though the light guide plate 18 exit effectively from the light exit surface, and improved brightness is achieved.

The light guide plates 18 include the first light guide plate 18A that is arranged in a first set of horizontally-arranged light guide plates and the second light guide plate 18B that is arranged in a second set of horizontally-arranged light guide plates next to the first set. The second light guide plate 18B overlaps the first light guide plate 18A in a direction crossing the light exit surface 36 on the relatively light exit side. The light exit surface 36 of the second light guide plate 18B is continuously connected to the light exit surface 36 of the first light guide plate 18A in the vertical direction. Thus, the light exit surface 36 of the first light guide plate 18A overlaps the light exit surface 36 of the second light guide plate 18B in the vertical direction, and therefore uneven brightness is less likely to be caused. In the overlapping area in which the first light guide plate 18A overlaps the second light guide plate 18B, the reflection sheet 24 provided on the second light guide plate 18B is provided between the first light guide plate 18A and the second light guide plate 18B. Therefore, the rays of light do not travel between the first light guide plate 18A and the second light guide plate 18B.

The second light guide plate 18B is provided such that the reflection sheet 24 of the second light guide plate 18B overlaps the LEDs 16 provided for the first light guide plate 18A on the relatively light exit side. Accordingly, the LEDs 16 provided for the first light guide plate 18A are covered with the reflection sheet 24 provided on the second light guide plate 18B. The LEDs 16 are not bare to the air layer AR1 (AR2) between the second light guide plates 18B. Therefore, the rays of light emitting from the LEDs 16 do not directly enter the air layer AR1 between the second light guide plates 18B and uneven brightness is less likely to be caused.

The light guide plates 18 include the third light guide plate 18C that is provided in a third set of the horizontally-arranged light guide plates next to the second set of the light guide plates including the second light guide plate 18B. The third light guide plate 18C is provided to overlap the second light guide plate 18B on the relatively light exit side. The reflection sheet 24 provided on the third light guide plate 18C overlaps the LEDs 16 provided for the first light guide plate 18A on the relatively light exit side. Accordingly, the LEDs 16 provided for the first light guide plate 18A are covered with the reflection sheet 24 provided on the third light guide plate 18C, and therefore, the LEDs 16 are not bare on the light exit side. Therefore, even if the air layer AR1 (AR2) between the second light guide plates 18B overlaps the LED 16 provided for the first light guide plate 18A on the light exit side, the rays of light emitting from the LED 16 does not leak toward the light exit side and uneven brightness is less likely to be caused.

The reflection sheet 24 is separately provided for each of the light guide plates 18 arranged in a set along the horizontal direction. Accordingly, each light guide plate 18 is handled independently with the reflection sheet 24 being provided thereon, and this improves handling properties.

End surfaces of the reflection sheet 24 in the horizontal direction are substantially on the same plane of the end surfaces of the light guide plate 18. Therefore, the reflection sheet 24 does not project to a space between the horizontally adjacent light guide plates 18. The air layer AR1 may be a dark point that has the lower amount of exiting light compared to the light exit surface 36. However, the air layers AR1 are not continuously connected to each other in the vertical direction, and therefore dark lines are less likely to be caused.

The light guide plates 18 are arranged such that the horizontal distance W1 from the air layer AR1 between the light guide plates 18 of a first set of the horizontally-arranged light guide plates to the air layer AR1 between the light guide plates 18 of a second set that is next to the first set is greater than the horizontal dimension W2 of the air layer AR1. Accordingly, each of the air layers AR1 provided in the adjacent sets of horizontally-arranged light guide plates is provided separately and independently from each other in the horizontal direction. Therefore, the air layers AR1 provided in the adjacent sets of horizontally-arranged light guide plates are not continuously connected to each other in the vertical direction. Therefore, the uneven brightness is less likely to be caused.

The light guide plate 18 includes a number of light entrance surfaces 34 and the slit 42 that divides the light exit surface 36 corresponding to the light entrance surfaces 34. The air layer AR2 is provided in the slit 42 and the LEDs 16 are arranged to correspond to the light entrance surfaces 34. The light guide plates 18 are arranged such that the slit 42 of the light guide plate 18 of a first set of the horizontally-arranged light guide plates and the slit 42 of the light guide plate 18 of a second set that is arranged next to the first set are located in different positions in the horizontal direction. Accordingly, the rays of light emitting from each LED 16 strikes each corresponding light entrance surface 34 and exits from each corresponding light exit surface 36 that is divided by the slit 42. Furthermore, the light guide plates 18 are arranged as mentioned before, and therefore the slits 42 are not continuously arranged in the vertical direction. Therefore, even if the amount of light exiting from the air layer AR2 (provided in the slit 42) area is different from that exiting from the light exit surface 36, the difference in the amount of exiting light is less likely to be recognized as uneven brightness areas. The light guide plate 18 is provided for a number of LEDs 16, the light guide plates 18 are arranged in series to be parallel to each other easily and this is especially preferable for a large backlight unit 12.

The slit 42 is provided to equally divide the light exit surface 36. Accordingly, the amount of rays of light exiting from each divided light exit surface 36S is equal and the uneven brightness is less likely to be caused.

The reflection sheet 24 for reflecting the light toward the light exit surface 36 is provided on a surface of the light guide plate 18 opposite from the light exit surface 36. The reflection sheet 24 is provided to cover the slit 42. Accordingly, the reflection sheet 24 is provided on the slit 42 area that divides the light exit surface 36 of the light guide plate 18. Therefore, if the light exiting from the light exit surface 36 reflects off another member to be directed to the air layer AR2 in the slit 42, the light reflects off the refection sheet 24 to be directed to the light exit side. This improves brightness.

The reflection sheet 24 is provided to be separately on each of the light guide plates 18 that are arranged in the horizontal direction and the end surfaces of the reflection sheet 24 in the horizontal direction are substantially on the same plane of the end surfaces of the light guide plate 18. Accordingly, the light guide plate 18 can be handled independently with being provided with the reflection sheet 24, and this improves handling property. The reflection sheet 24 is not projected to a space between the horizontally adjacent light guide plates 18. The air layer AR1 between the light guide plates 18 may be a dark point from which a smaller amount of light exits. The air layers AR1 are not continuously arranged in the vertical direction and therefore dark lines are less likely to be caused.

The air layer AR1 provided between the horizontally adjacent light guide plates 18 and the low reflective index layer AR2 provided in the slit 42 have a substantially same horizontal dimension W2. Therefore, the uneven brightness is less likely to be caused.

The air layers AR1, AR2 are the low reflective index layers that have lower reflective index than the light guide plate 18. Accordingly, a special member for forming the low reflective index layer is not required, and this reduces a cost.

The light source is the LED 16. This improves brightness.

### Second Embodiment

Next, the second embodiment of the present invention will be explained with reference to FIGS. 18 to 20. In the second embodiment, the reflection sheet 24 of the first embodiment is altered to a reflection sheet 24-A. The same components as the first embodiment will be indicated with the same symbols. The symbols with the letter A are used for referring to the same parts as the first embodiment. The same configuration, functions and effects will not be explained.

As illustrated in FIGS. 18 and 19, the reflection sheet 24-A is continuously formed to cover the horizontally arranged light guide plates 18-A. Specifically, the reflection sheet 24-A is formed in a belt-like shape extending in the horizontal direction. The light guide plates 18-A are arranged with a predetermined distance (gap C1-A) therebetween. Therefore, the reflection sheet 24-A covers the slits 42-A on the light guide plates 18-A and also covers the spaces between the horizontally adjacent light guide plates 18-A. As illustrated in FIG. 20, the reflection sheet 24-A is bare to the gaps C1-A between the horizontally adjacent light guide plates 18-A similar to the gaps C2-A in the slits 42-A.

When the LEDs 16 are lit, the amount of rays of light exiting from each of the gap C1-A area and the gap C2-A area is different from the amount of rays of light exiting from the light exit surface 36-A. However, the amount of rays of light exiting from the gap C1-A area between the horizontally adjacent light guide plates 18-A and the amount of rays of light exiting from the gap C2-A (in the slit 42-A) area are substantially same. The reflection sheet 24-A is provided on the rear-surface side of each of the gaps C1-A and the gaps C2-A. Therefore, the rays of light exiting from the light exit surface 36-A and reflecting off another member such as the optical member to be returned to the light exit surface 36-A reflect off the reflection sheet 24-A again to be directed to the front-surface side. This improves light use efficiency and also improves brightness. The amount of rays of light exiting from each of the gaps C1-A and the gaps C2-A is equalized. Compared to the case in which the amount of light exiting from each of the gaps C1-A, C2-A is varied, the uneven brightness is less likely to be caused.

As explained before, according to the second embodiment, the reflection sheet 24-A is provided continuously over the horizontally-arranged light guide plates 18-A. Accordingly, compared to the case in that the reflection sheet is separately provided on each of the light guide plates, the number of parts of the reflection sheet 24-A is reduced and the reflection sheet 24-A is provided on the light guide plate 18-A easily. Furthermore, the reflection sheet 24 is provided on the gaps C1-A (the air layers) between the adjacent light guide plates 18-A and on the gaps C2-A (the air layers) in the slits 42-A. Therefore, for example, if the rays of light emitting from the light exit surface 36-A reflect off another member to be directed into the gaps C1-A between the adjacent light guide plates 18-A or the gaps C2-A in the slits 42-A, the rays of light are reflected by the reflection sheet 24-A toward the light exit side. This improves brightness.

### Third Embodiment

Next, the third embodiment of the present invention will be explained with reference to FIG. 21. In the third embodiment, the arrangement patterns AP1, AP2 of the light guide plates are altered from the first embodiment. The same components as the first embodiment will be indicated with the same symbols. The symbols with the letter B are used for referring to the same parts as the first embodiment. The same configuration, functions and effects will not be explained.

The first light guide plates 18A-B of the first arrangement pattern AP1-B and the second light guide plates 18B-B of the second arrangement pattern AP2-B are offset from each other by an offset distance W5 in the horizontal direction. As illustrated in FIG. 21, the offset distance W5 is approximately a half of a horizontal width W6 of the divided light guide portion 32S-B and the divided light exit portion 31S-B (the divided light exit surface 36S-B) of each light guide plate 18-B. Therefore, each gap C1-B, C2-B of the second light guide plates 18B-B of the second arrangement pattern AP2-B is located at a middle portion between the gap C1-B and the gap C2-B of the first light guide plates 18A-B of the first arrangement pattern AP1-B. Accordingly, the gaps C1-B, C2-B of the first guide plates 18A-B of the first arrangement pattern AP1-B and the gaps C1-B, C2-B of the second guide plates 18B-B of the second arrangement pattern AP2-B are arranged evenly on a plane of the light exit surface 36-B. Therefore, the uniform in-plane brightness distribution is achieved and uneven brightness is less likely to be caused. The gaps C1-B, C2-B of the first light guide plates 18A-B of the first arrangement pattern AP1-B and the gaps C1-B, C2-B of the second light guide plates 18B-B of the second arrangement pattern AP2-B are separated farthest from each other in the horizontal direction. Therefore, the uneven brightness is less likely to be caused.

In such an arrangement of the light guide plates 18-B, the LEDs 16-B provided for the first light guide plate 18A-B overlap in a plan view the gaps C1-B, C2-B of the second light guide plates 18B-B. The rays of light emitting from the LEDs 16-B may be directly irradiated to the diffuser on the front-surface side through the gaps C1-B, C2-B. In the present embodiment, the third light guide plates 18C-B and the reflection sheets 24-B overlap the LEDs 16-B provided for the first light guide plate 18A-B on the front-surface side. The LEDs 16-B are not bare on the front-surface side. Accordingly, even if the rays of light emitting from the LED 16-B enter the gap C1-B or the gap C2-B of the second light guide plate 18B-B, the rays of light are directed to the rear-surface side by the third light guide plate 18C-B and the reflection sheet 24-B provided thereon. The leak light is less likely to be caused and also the uneven brightness is less likely to be caused.

As explained before, according to the third embodiment, the light guide plates 18-B are arranged so as to have the offset distance W5 between the gaps C1-B, C2-B (the air layer) on the light guide plate 18-B of a first set of horizontally-arranged light guide plates and the gaps C1-B, C2-B (the air layer) on the light guide plate 18-B of a second set of horizontally-arranged light guide plates that is next to the first set. The offset distance W5 is set to be approximately a half of the horizontal width W6 on the light guide plate 18-B. With this configuration, the gap C1-B, C2-B of the second set is arranged at a middle portion between the gap C1-B and the gap C2-B of the first set. Namely, the gaps C1-B and the gaps C2-B are arranged evenly on a plane of the light exit surface 36-B. Therefore, the uneven brightness is less likely to be caused.

### Fourth Embodiment

Next, the fourth embodiment of the present invention will be explained with reference to FIG. 22. In the fourth embodiment, three arrangement patterns of the light guide plates are provided. The same components as the first embodiment will be indicated with the same symbols. The symbols with the letter C are used for referring to the same parts as the first embodiment. The same configuration, functions and effects will not be explained.

As illustrated in FIG. 22, three arrangement patterns of the light guide plates 18-C are provided. In FIG. 22, a first set of the light guide plates that is arranged on the upper side (front side) has a first arrangement pattern AP1-C, and a second set of the light guide plates that is arranged next to the first set and on the lower side (rear side) of the first arrangement pattern AP1-C is a second arrangement pattern AP2-C, and a third set of the light guide plates that is arranged next to the second set and on the lower side of the second arrangement pattern AP2-C is a third arrangement pattern AP3. The light guide plates 18-c are arranged such that the first arrangement pattern AP1-C, the second arrangement pattern AP2-C and the third arrangement pattern AP3 are arranged in this order from the front side repeatedly in the vertical direction. Thus, the three types of arrangement patterns AP1-C, AP2-C and AP3 are arranged in a regular manner. The light guide plate 18-C of the first arrangement pattern AP1-C and the light guide plate 18-C of the second arrangement pattern AP2-C are offset in the horizontal direction by an offset distance W7. The light guide plate 18-C of the second arrangement pattern AP2-C and the light guide plate 18-C of the third arrangement pattern AP3 are offset in the horizontal direction by an offset distance W8. The offset distance W7 is substantially equal to the offset distance W8. Each of the offset distance W7 and the offset distance W8 is approximately one third of a horizontal width W6 of the divided light guide portion 32S-C and the divided light exit portion 31S-C (the divided light exit surface 36S-C) of the light guide plate 18-C. Namely, each of the offset distance W7 and the offset distance W8 is set to be a dimension obtained by dividing the horizontal width W6 by the number of arrangement patterns. Therefore, the gaps C1-C, C2-C on the light guide plates 18-C of the arrangement patterns AP1-C to AP3 are provided in the horizontal direction at equal intervals. Accordingly, the gaps C1-C, C2-C are evenly arranged on a plane of the light exit surface 36-C.

### Other Embodiments

The present invention is not limited to the above embodiments explained in the above description. The following embodiments may be included in the technical scope of the present invention, for example.

(1) The horizontal offset distance between the light guide plates of the horizontally adjacent sets of the light guide plates may be altered as necessary. For example, the offset distance that is required to prevent that the gaps of the light guide plates are arranged continuously in the vertical direction is set to a dimension of a total of the horizontal dimension of the gap and a horizontal error dimension related to assembling of the light guide plates. The offset distance may be substantially equal to or smaller than the horizontal dimension of the gap. The allowable largest dimension of the offset distance is a half of the horizontal dimension of the light guide plate. As the offset distance is set to be greater, the gaps of the adjacent sets of the horizontally-arranged light guide plates are located farther from each other in the horizontal direction. Therefore, the uneven brightness is less likely to be caused.

(2) In the first to third embodiments, the two arrangement patterns are arranged alternately in the vertical direction. However, the same arrangement patters may be arranged in the vertical direction.

(3) In the fourth embodiment, the three arrangement patterns are arranged such that the first arrangement pattern, the second arrangement pattern and the third arrangement pattern are arranged in this order in the vertical direction. However, the specific arrangement order of the arrangement patterns may be altered as necessary. In altering the arrangement order, it is preferable to arrange the light guide plates such that the adjacent sets of the horizontally-arranged light guide plates have different arrangement patterns. Accordingly, a number of the air layers (the gaps) in the adjacent sets of the light guide plates are not continuously arranged in the vertical direction. Therefore, the uneven brightness is less likely to be caused.

(4) Four or more arrangement patterns may be provided. In such a case, it is preferable to arrange the light guide plates such that the adjacent sets of the horizontally-arranged light guide plates have different arrangement patterns. Accordingly, a number of the air layers (the gaps) in the adjacent sets of the horizontally-arranged light guide plates are not continuously arranged in the vertical direction. Therefore, the uneven brightness is less likely to be caused.

(5) In the above embodiments, a number of arrangement patterns are arranged repeatedly in a regular manner. However, a number of arrangement patterns may be arranged arbitrarily in an irregular manner.

(6) In the above embodiments, the gap between the horizontally-arranged light guide plates and the gap in the slit on the light guide plate are same in the width. However, the width of them may be different. Each gap between the horizontally-arranged light guide plates may have a different width dimension.

(7) In the second embodiment, a number of light guide plates are arranged on a single reflection sheet. The specific number of light guide plates that are to be collectively arranged on the reflection sheet may be appropriately determined. The specific number of light guide plates is not specified.

(8) In the first to third embodiments, the side end surfaces of the light guide plate are on substantially the same plane as the side end surfaces of the reflection sheet. For example, the side end surface of the reflection sheet may be located outside of the side end surface of the light guide plate. Namely, the side end surface of the reflection sheet may be projected into the gap between the horizontally adjacent light guide plates. Accordingly, the reflection sheet may be provided on the gap between the horizontally adjacent light guide plates and on the gap in the slit. Therefore, the uneven brightness is less likely to be caused and brightness is improved.

(9) In the above embodiments, a number of the arrangement patterns of the light guide plates are provided such that the gap between the horizontally-arranged light guide plates of a first set is offset from the gap between the horizontally-arranged light guide plates of a second set that is next to the first set. However, a number of the light guide plates having different structures maybe prepared to achieve the above-mentioned arrangement of the gaps. Specifically, each light guide plates of a first set of the horizontally-arranged light guide plates and each one of a second set that is next to the first set in the vertical direction have a different horizontal size or a different slit position.

(9) In the above embodiments, the air layers are used as the low reflective index layers. A low reflective index layer made of a low reflective index material may be provided in each gap between the light guide plates.

(10) In the above embodiments, each light guide plate has a single slit and two divided light exit portions and two divided light guide portions (the light entrance surfaces) are provided. However, each light guide plate may have two or more slits and three or more divided light exit portions and three or more divided light guide portions (the light entrance surfaces) may be provided. With such a configuration, a single light guide plate can collectively cover three or more LEDs. This makes assembly of the backlight unit easier. In such a case also, the light guide plate may be preferably fixed by the fixing members such as the clips at two fixing positions that collectively hold the LEDs.

(11) In the above embodiments, each light guide plate has the slit that divides the light exit portion and the light guide portion so that the single light plate collectively covers a number of LEDs. However, each light guide plate may not have the slit and each light guide plate may include a single LED (i.e., a single light entrance surface). With this configuration, light from the adjacent LED that is not an object to be covered by a specific light guide plate is less likely to enter the specific light guide plate. In such a case also, the light guide plate may be preferably fixed by the fixing members such as the clips at two fixing positions that collectively hold the LEDs.

(12) In the above embodiments, each light guide plate has a rectangular shape in a plan view. However, each light guide plate may have a square shape in a plan view. The lengths, the widths, the thicknesses and the outer surface shapes of each board mounting portion, each light guide portion and each light exit portion can be altered as necessary.

(13) In the above embodiments, each LED emits light upward in the vertical direction. However, the light emitting direction of each LED 16 can be altered as necessary. Namely, each LED 16 can be mounted to the LED board 17 in a suitable position. Specifically, each LED 16 can be mounted to the LED board 17 so as to emit light downward in the vertical direction, or such that the light emitting direction (the light axis) aligned with the horizontal direction. The LEDs 16 with different light emitting directions may be included.

(14) In the above embodiments, the light guide plates are arranged so as to overlap each other in a plan view. However, the light guide plates may be arranged so as not to overlap each other in a plan view. In such a case, the reflection sheet is not provided on each light guide plate but a large reflection sheet may be provided on the LED board.

(15) In the above embodiments, each LED includes three different LED chips configured to emit respective colors of RGB. However, LEDs each including a single LED chip configured to emit a single color of blue or violet and each configured to emit white light using fluorescent material may be used.

(16) In the above embodiments, each LED includes three different LED chips configured to emit respective colors of RGB. However, LEDs each including three different LED chips configured to emit respective colors of cyan (C), magenta (M) and yellow (Y) may be used.

(17) In the above embodiments, the LEDs are used as point light sources. However, point light sources other than LEDs can be used.

(18) In the above embodiments, the point light sources are used as the light sources. However, linear light sources such as cold cathode tubes and hot cathode tubes may be used. In such a case, a single linear light source may be provided to face each light entrance surface of a number of light guide plates that are arranged in the horizontal direction and light is supplied collectively to the light guide plates.

(19) Planar light sources such as organic ELs may be used other than the above embodiments and the embodiments (17) and (18).

(20) The optical member may be configured differently from the above embodiments. Specifically, the number of diffusers or the number and the kind of the optical sheets can be altered as necessary. Furthermore, a plurality of optical sheets in the same kind may be used.

(21) In the above embodiments, the liquid crystal panel and the chassis are held in the vertical position with the short-side direction thereof aligned with the vertical direction. However, the liquid crystal panel and the chassis may be held in the vertical position with the long-side direction thereof aligned with the vertical direction.

(22) In the above embodiments, TFTs are used as switching components of the liquid crystal display device. However, the technology described the above can be applied to liquid crystal display devices including switching components other than TFTs (e.g., thin film diode (TFD)). Moreover, the technology can be applied to not only color liquid crystal display devices but also black-and-white liquid crystal display devices.

(23) In the above embodiments, the liquid crystal display device including the liquid crystal panel as a display component is used in the above embodiment. The technology can be applied to display devices including other types of display components.

(24) In the above embodiments, the television receiver including the tuner is used. However, the technology can be applied to a display device without a tuner.

1. A lighting device comprising:
a light source;
light guide members; and
a low reflective index layer having a reflective index lower than the light guide members,
each light guide member including:
a light entrance surface provided to face the light source and that light from the light source enters; and
a light exit surface provided to be parallel to an arrangement direction in which the light source and the light entrance surface are arranged and through which the light exits, the light guide members being arranged in a vertical direction that is the arrangement direction and in a horizontal direction that is a direction parallel to the light exit surface and perpendicular to the arrangement direction,
the low index layer being provided between adjacent light guide members that are arranged in the horizontal direction, and
the low reflective index layer between the light guide members of one set of the horizontally-arranged light guide members being offset from the low reflective index layer between the light guide members of another set of the horizontally-arranged light guide members that is next to the one set.

2. The lighting device according to claim 1, wherein the light guide members are arranged in a number of horizontal arrangement patterns and the low reflective index layer between the light guide members in each of the arrangement patterns is offset from each other in the horizontal direction and the arrangement patterns are provided repeatedly in a predetermined order in the vertical direction.

3. The lighting device according to claim 2, wherein two arrangement patterns are provided.

4. The lighting device according to claim 3, wherein the two arrangement patterns are alternately arranged in the vertical direction.

5. The lighting device according to claim 2, wherein the light source includes a number of light sources and each of the light sources is arranged to correspond to each light entrance surface of the light guide members of each arrangement pattern, and the light sources are arranged in the vertical direction and in the horizontal direction.

6. The lighting device according to claim 2, further comprising:
a base member on which the light source and the light guide member are mounted; and
fixing structures for fixing the light guide member to the base member, the fixing structures provided on the base member and the light guide member, wherein the fixing structures are arranged in the vertical direction and in the horizontal direction on the base member corresponding to each of the light guide members of each arrangement pattern.

7. The lighting device according to claim 1, further comprising a reflection member provided on a surface of the light guide member opposite from the light exit surface and configured to reflect the light toward the light exit surface side.

8. The lighting device according claim 7, wherein the light guide members include first light guide members in one set of the horizontally-arranged light guide members and second light guide members in another set of the horizontally-arranged light guide members that is provided next to the one set, the second light guide members overlapping the first light guide members in a direction perpendicular to the light exit surface and relatively on the light exit side, the light exit surface of the second light guide member is provided continuously from the light exit surface of the first light guide member.

9. The lighting device according to claim 8, wherein the second light guide member overlaps the light source corresponding to the first light guide member relatively on the light exit side.

10. The lighting device according to claim 8, wherein:
the light guide members include third light guide members in a set of the horizontally-arranged light guide members that is provided next to the another set including the second light guide members and the third light guide members overlap the second light guide members relatively on the light exit side; and
the third light guide member has a reflection member that overlaps the light source corresponding to the first light guide member on the relatively light exit side.

11. The lighting device according to claim 7, wherein the reflection member is continuously provided over the horizontally-arranged light guide members.

12. The lighting device according to claim 7, wherein the reflection member is separately provided on each of the horizontally-arranged light guide members.

13. The lighting device according to claim 12, wherein the reflection member has end surfaces in the horizontal direction that are substantially on the same plane as end surfaces of the light guide member.

14. The lighting device according to claim 1, wherein a horizontal distance from the low reflective index layer between the light guide members of the one set to the low reflective index layer between the light guide members of the another set that is next to the one set is substantially equal to or greater than a horizontal dimension of the low reflective index layer.

15. The lighting device according to claim 14, wherein the horizontal distance between the low reflective index layer between the light guide members of the one set and the low reflective index layer between the light guide members of the another set that is next to the one set is greater than the horizontal dimension of the low reflective index layer.

16. The lighting device according to claim 15, wherein the horizontal distance between the low reflective index layer between the light guide members of the one set and the low reflective index layer between the light guide members of the another set that is next to the one set is approximately a half of a horizontal dimension of the light guide member.

17. The lighting device according to claim 1, wherein:
each light guide member further includes a number of the light entrance surfaces and a slit that divides the light exit surface into a number of areas corresponding to the light entrance surfaces, and the low reflective index layer is provided in the slit and light sources are provided corresponding to the light entrance surfaces; and
the slit of the light guide member of the one set is offset in the horizontal direction from the slit of the light guide member of the another set that is next to the one set.

18. The lighting device according to claim 17, wherein the slit equally divides the light exit surface.

19. The lighting device according to claim 17, wherein the light guide member has a reflection member on a surface opposite from the light exit surface and light reflects off the reflection member toward the light exit surface side.

20. The lighting device according to claim 19, wherein the reflection member is continuously provided over the horizontally-arranged light guide members.

21. The lighting device according to claim 19, wherein the reflection member is provided separately on each of the horizontally-arranged light guide members and end surfaces of the reflection member in the horizontal direction are substantially on a same plane as end surfaces of the light guide member.

22. The lighting device according to claim 17, wherein the low reflective index layer provided between the horizontally adjacent light guide members and the low reflective index layer provided in the slit have a substantially same horizontal dimension.

23. The lighting device according to claim 1, wherein the low reflective index layer is an air layer.

24. The lighting device according to claim 1, wherein the light source is a light emitting diode.

25. A display device comprising:
the lighting device according to claim 1; and
a display panel configured to provide display using light from the lighting device.

26. The display device according to claim 25, wherein the display panel is a liquid crystal panel including liquid crystals sealed between a pair of substrates.

27. A television receiver comprising the display device according to claim 25.
